(19) United States
(12) Patent Application Publication
(10) Pub. No.: US 2013/0293824 A1
(43) Pub. Date: Nov. 7, 2013

(54) METHOD FOR PRODUCING OPTICAL FILM, OPTICAL FILM PRODUCED BY THE METHOD, AND POLARIZING PLATE AND IMAGE-FORMING DISPLAY DEVICE HAVING THE FILM

(71) Applicant: FUJIFILM CORPORATION, Tokyo (JP)

(72) Inventors: Hiroyuki YONEYAMA, Kanagawa (JP); Yuta TAKAHASHI, Kanagawa (JP); Miho ASAHI, Kanagawa (JP); Junko IBARAKI, Kanagawa (JP)

(21) Appl. No.: 13/858,649

(22) Filed: Apr. 8, 2013

Related U.S. Application Data
(63) Continuation of application No. PCT/JP2011/073765, filed on Oct. 7, 2011.

(30) Foreign Application Priority Data
Oct. 8, 2010 (JP) 2010-229146

(51) Int. Cl. G02B 5/30; G02B 1/10

(52) U.S. Cl. CPC G02B 5/3016; G02B 1/105
USPC 349/194; 156/60

(57) ABSTRACT

A method for producing an optical film including: laminating a hard coat layer on one side of an optical substrate in roll form, the hard coat layer having a transparent support and an optical anisotropic layer. The transparent support is laminated on the optical anisotropic layer, the one side is a transparent support-side of the optical substrate, the hard coat layer is obtained by coating, drying and curing a composition for forming a hard coat layer containing a curable monomer, a photo-polymerization initiator, and a solvent. The solvent is a mixture of at least one solvent selected from (S-1) and (S-2) and at least one solvent selected from (S-3), or a mixture of at least one solvent selected from (S-1) and at least one solvent selected from (S-2): (S-1) solvents dissolving the transparent support; (S-2) solvents swelling the transparent support; and (S-3) solvents neither dissolving nor swelling the transparent support.

### CROSS-REFERENCE TO RELATED APPLICATIONS

This application is a Continuation of International Application No. PCT/JP2011/073765 filed on Oct. 7, 2011, which was published under PCT Article 21(2) in Japanese, which is based upon and claims the benefit of priority from Japanese Patent Application No. 2010-229146 filed on Oct. 8, 2010, the contents both of which are incorporated herein by reference.

### TECHNICAL FIELD

The present invention relates to a method for producing optical film having a cured liquid crystalline compound, an optical film produced by the method, and a polarizing plate and an image-forming display device having the film.

### BACKGROUND ART

A so-called retardation film to which various functions are imparted by controlling retardation of the film has been used for various applications.

For example, retardation films have been designed for the purpose of expanding a viewing angle depending upon mode of a different kind of liquid crystal cell in a liquid crystal display. Also, beside liquid crystal display devices, λ/4 plates having retardation of ¼ wavelength are being used as brightness enhancement films, pickups for an optical disc, or PS converters.

As methods for developing such retardation, there are known a method of stretching a polymer film, a method of coating a coating liquid containing a liquid crystalline compound on a substrate and aligning in a predetermined direction to thereby develop optical anisotropy, and the like. Of them, a method of controlling retardation using a liquid crystalline compound enables one to variously control retardation by properly selecting an alignment film, a liquid crystalline compound, an alignment-controlling agent for the liquid crystalline compound, process conditions for controlling alignment, and the like, can be applied widely, and can produce the product on a large scale with high speed (JP-A-2001-4837 (the term “JP-A” as used herein means an “unexamined published Japanese patent application”) and JP-A-2004-53841).

Also, as applications of the retardation plate, it has been proposed to apply it to organic electroluminescence devices, touch panels, 3D display devices, etc. with a structure wherein the plate is used at the front end position and not inside the device. However, conventional retardation plates have such problems as that they are liable to form scratches and are insufficient in strength, that they show a high reflectance when irradiated with outer light, that they have poor light fastness, and that stains are liable to deposit thereon and are difficult to remove. Thus, for use as a plate at the front end position, the plates have been required to be more improved.

In order to protect a liquid crystalline compound layer, a technique has been disclosed wherein a highly hard protective film is provided on the liquid crystalline compound layer (JP-A-2004-126534). However, it has been found that, since the liquid crystalline compound layer generally has optical anisotropy, merely providing a protective film having no optical anisotropy on the liquid crystalline compound layer causes a problem that light interference conditions so greatly differ depending upon viewing angle that rainbow-like unevenness or the like tends to occur.

The inventors have investigated to provide a hard coat layer on the side of a support on which side the liquid crystalline compound layer is not provided by coating. As a result, it has been found that, in comparison with common transparent supports, the support tends to repel a coating solution of the hard coat and tends to cause coating trouble. As a result of analysis, projections of a matting agent used for forming projections for preventing adhesion of the transparent support roll film tend to cause adhesion. Further, it has also been found that, after storage of an optical substrate, in a roll state, on which the liquid crystalline compound layer is provided by coating, additives such as a fluorine-containing compound in the liquid crystalline compound layer migrate to the surface of the transparent substrate which is in contact with the liquid crystalline compound layer in order to more enhance repelling.

For solving this repelling problem, the following means has been found to be effective, thus the invention being completed.

### SUMMARY OF THE INVENTION

The present invention has been made in consideration of the above-described various problems, and the object of the invention is to provide an optical film which can be produced with high productivity and which has an optically anisotropic layer having physical performance capable of using it at the front end position of a display device.

The above-described object can be attained by the following constitution.

(1) A method for producing an optical film having: laminating a hard coat layer on one side of an optical substrate wound in a roll form, the optical substrate having a transparent support and an optical anisotropic layer, wherein the transparent support is laminated on the optical anisotropic layer, said one side is a transparent support-side of the optical substrate, the hard coat layer is formed by coating, drying and curing a composition for forming a hard coat layer containing a curable monomer, a photo-polymerization initiator, and a solvent, and the solvent is a mixture of at least one solvent selected from (S-1) and (S-2) and at least one solvent selected from (S-3), or a mixture of at least one solvent selected from (S-1) and at least one solvent selected from (S-2): (S-1) solvents dissolving the transparent support; (S-2) solvents swelling the transparent support; and (S-3) solvents neither dissolving nor swelling the transparent support.
(2) The method for producing an optical film according to (1), wherein the solvent (S-1) dissolving the transparent support is methyl acetate or acetone, the solvent (S-2) swelling the transparent support is methyl ethyl ketone, dimethyl carbonate, or methyl ethyl carbonate, and the solvent (S-3) neither dissolving nor swelling the transparent support is methyl isobutyl ketone or toluene.
(3) The method for producing an optical film according to (1) or (2), wherein projections of from 0.1 to 3 nm are formed by matt particles on the transparent-support-side of the optical substrate.
(4) The method for producing an optical film according to any one of (1) to (3), wherein the monomer contained in the composition for forming the hard coat layer is a mixture of (2a) and (2b) described below, and the content of (2a) is more than the content of (2b): (2a) compound having 3 or more functional groups per molecule, wherein an SP value of the monomer (2a) measured by Hoy method is more than 19 and less than 25 and a weight-average molecular weight of the monomer (2a) is more than 40 and less than 1600, and (2b) urethane compound having 3 or more functional groups per molecule, wherein an SP value of the monomer (2b) measured by Hoy method is more than 19 and less than 25 and an absolute value of differences a weight-average molecular weights of the monomer (2a) and the monomer (2b) is 150 ore more and 500 or less.
(5) The method for producing an optical film according to any one of (1) to (4), wherein the monomer contained in the composition for forming the hard coat layer is a mixture of (1a) and (1b) described below, and the content ratio of (1a) to (1b) is 0.5% by weight to 10% by weight: (1a) compound having 2 or less functional groups per molecule, wherein a weight-average molecular weight of the monomer (1a) is more than 40 and less than 500 and an SP value of the monomer (1a) measured by Hoy method is more than 19 and less than 24.5, and (1b) compound having 3 or more functional groups per molecule, wherein a weight-average molecular weight of the monomer (1b) is more than 100 and less than 1600, an SP value of the monomer (2b) measured by Hoy method is more than 19 and less than 24.5, and a ratio of the weight-average molecular weight of the monomer (1b) to a number of functional groups per molecule is more than 70 and less than 300.
(6) The method for producing an optical film according to (5), wherein the weight-average molecular weight of the monomer (1a) is more than 40 and less than 250.
(7) The method for producing an optical film according to any one of (1) to (6), wherein at least part of the monomer contained in the composition for forming the hard coat layer is the following (Aa): (Aa) a compound having 1 or more photo-polymerizable group and having a structure of —(CH₂CH₂O)ₙ—, wherein n represents a number of 1 to 50.
(8) The method for producing an optical film according to (7), wherein the compound (Aa) contains 2 or 3 (meth)acryloyloxy groups and n is a number of 1 to 30.
(9) The method for producing an optical film according to any one of (1) to (8), wherein the composition for forming the hard coat layer further contains a conductive compound (f).
(10) The method for producing an optical film according to any one of (1) to (9), wherein the optical film has an in-plane retardation at 550 nm of from 80 to 200 nm and an Nz value represented by the following formula of from 0.1 to 0.9: Nz value=0.5+Rth/Re, wherein Rth represents a retardation in a thickness direction.
(11) The method for producing an optical film according to any one of (1) to (10), wherein the transparent support of the optical substrate containing a cellulose acylate.
(12) The method for producing an optical film according to any one of (1) to (11), wherein at least one functional layer selected from the group consisting of an antireflection layer, an antistatic layer, a UV ray-absorbing layer, and an antifouling layer is further formed on the surface of the hard coat layer.
(13) An optical film having: an optically anisotropic layer containing a liquid crystalline compound; a transparent support; and a hard coat layer, wherein the optically anisotropic layer, the transparent support, and the hard coat layer are laminated in this order, and the hard coat layer is produced by the method according to (1) to (12).
(14) An optical film having: an optically anisotropic layer containing a liquid crystalline compound; a transparent support; and a hard coat layer, wherein the optically anisotropic layer, the transparent support, and the hard coat layer are laminated in this order, and a gradation region in which a compound localization gradually changes is formed between the hard coat layer and the transparent support.
(15) The optical film according to (14), wherein a thickness of the gradation region based on a thickness of the hard coat layer is from 5 to 150%.
(16) The optical film according to any one of (13) to (15), wherein at least one functional layer selected from the group consisting of an antireflection layer, an antistatic layer, a UV ray-absorbing layer, and an antifouling layer is further formed on the surface of the hard coat layer.
(17) The optical film according to any one of (13) to (16), wherein the optical film has an in-plane retardation at 550 nm of from 80 to 200 nm and an Nz value represented by the following formula of from 0.1 to 0.9: Nz value=0.5+Rth/Re, wherein Rth: retardation in a thickness direction.
(18) A polarizing plate using as a protective film the optical film according to any one of (13) to (17).
(19) An image display device having at least one of the optical film according to any one of (13) to (17) and the polarizing plate according to (18).

According to the production method of the present invention, there can be provided an optical film which can suppress repelling problems, which does not cause interference unevenness, and which has excellent physical properties.

### BRIEF DESCRIPTION OF DRAWINGS

FIGS. 1A, 1B and 1C are cross-sectional schematic views showing examples of an optical film of the invention.

FIGS. 2A and 2B are cross-sectional schematic views showing examples of a polarizing plate of the invention.

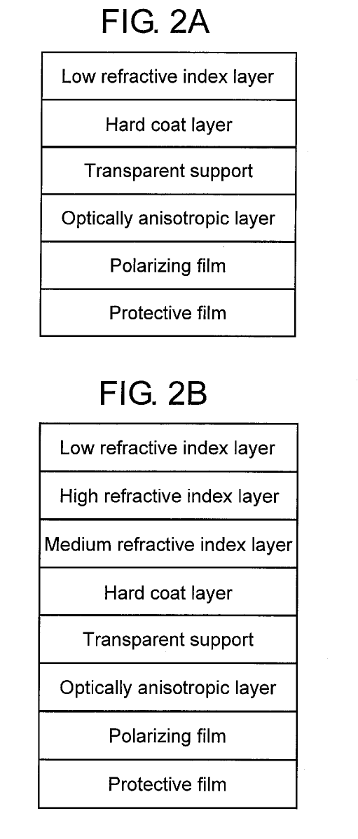

### DESCRIPTION OF EMBODIMENTS

Embodiments for carrying out the present invention will be described in detail below, but the present invention is not limited thereto. Additionally, in this specification, when a numerical value represents a physical value or a characteristic value, the numerical range represented by “from (numerical value 1) to (numerical value 2)” means the range of “(numerical value 1) or more and (numerical value 2) or less”.

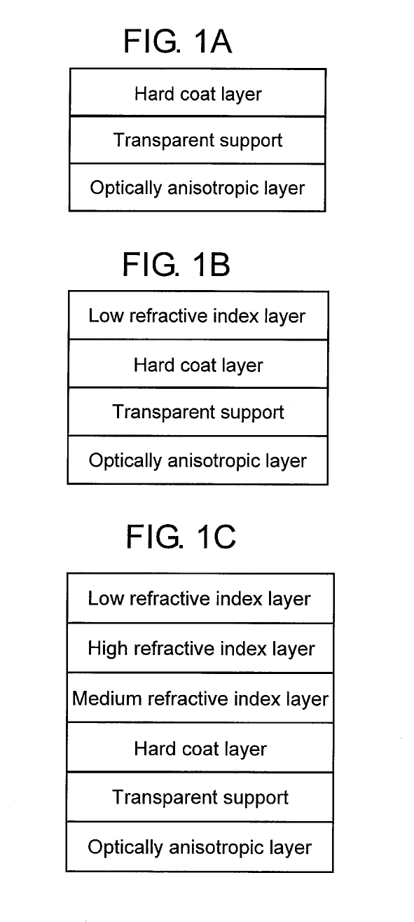

An optical film of the invention is a layered body wherein an optically anisotropic layer containing a crystalline compound layer is formed on one side of a transparent support and a hard coat layer is formed on the other side of the transparent support. An alignment film which functions to control alignment of the liquid crystalline compound may optionally be provided between the transparent support and the optically anisotropic layer containing liquid crystalline compound. Other functional layer may further be provided on the hard coat layer. Specific examples of such functional layer include an anti-reflection layer (a high refractive index layer, a medium refractive index layer, or a low refractive index layer), an antistatic layer, a UV ray-absorbing layer, and an antifouling layer. The hard coat layer may also have the functions of these functional layers. FIGS. 1A, 1B and 1C are conceptual views showing structural examples of the retardation film layered body of the invention.

Although optical properties of the optical film of the invention are not particularly specified, an in-plane retardation Re at 550 nm is preferably from 5 to 300 nm, more preferably from 10 to 250 nm, most preferably from 80 to 200 nm. Also, an Nz value to be defined hereinafter is preferably from 0 to 2.0, more preferably from 0.1 to 1.6, most preferably from 0.1 to 0.9 (here, Nz value=0.5+Rth/Re, with Rth being a retardation in a thickness direction; methods for measuring these optical properties being described hereinafter). In particular, with a λ/4 plate, Re and the Nz value are preferably from 80 to 200 nm and from 0.1 to 0.9, respectively, more preferably, from 100 to 150 nm and from 0.1 to 0.9, respectively.

The optical film of the present invention has high productivity because the optically anisotropic layer and the hard coat layer can be laminated by a roll to roll process. The optical film of the present invention is produced by: forming an optical substrate made by stacking the optical anisotropic layer having the liquid crystalline compound on one side of the transparent substrate; rolling up the optical substrate; and forming the hard coat layer by coating a composition for forming the hard coat layer, which includes a solvent, on the other side of the optical substrate, and then drying and curing it. The composition for forming the hard coat layer contains a curable monomer, a photo-polymerization initiator, and a solvent, and the solvent is a mixture of at least one solvent selected from (S-1) and (S-2) and at least one solvent selected from (S-3), or a mixture of at least one solvent selected from (S-1) and at least one solvent selected from (S-2):

(S-1) solvents dissolving the transparent support;
(S-2) solvents swelling the transparent support; and
(S-3) solvents neither dissolving nor swelling the transparent support.

This production method can provide an optical film which can suppress occurrence of repelling upon formation of the hard coat layer, which causes less interference unevenness, and which has excellent physical properties.

Materials to be used for the optical film, polarizing plate, and image display device of the invention, and the methods for their production will be described in detail below.

[Composition for Forming Hard Coat Layer]

In the invention, a hard coat layer is a layer which can enhance pencil hardness of the transparent support by providing the hard coat layer on a transparent support. In a practical viewpoint, the pencil hardness (JIS K5400) after forming the hard coat layer is preferably H or more, more preferably 2H or more, most preferably 3H or more. The thickness of the hard coat layer is preferably from 0.4 to 35 μm, more preferably from 1 to 30 μm, most preferably from 1.5 to 20 μm.

The composition for forming the hard coat layer to be used in the method of the invention for producing an optical film contains a curable monomer, a photo-polymerization initiator, and a solvent. The solvent to be used is a mixture of at least one solvent selected from (S-1) and (S-2) and at least one solvent selected from (S-3), or a mixture of at least one solvent selected from (S-1) and at least one solvent selected from (S-2). This solvent composition serves to markedly reduce repelling problems upon coating the hard coat layer.

(S-1) solvents dissolving the transparent support
(S-2) solvents swelling the transparent support
(S-3) solvents neither dissolving nor swelling the transparent support

In the present invention, the solvent (S-1) dissolving the transparent support is defined as follows.

A solvent is defined as (S-1) when a solution prepared by dipping a 24 mm×36 mm size substrate film in a 15 cc bottle containing the solvent for 60 seconds at room temperature (25° C.) and then removing the substrate from the bottle, shows a peak area of the transparent support components of 400 mV/sec or more upon analysis by gel permeation chromatography (GPC).

A solvent is alternatively defined as (S-1) when the solvent has dissolving ability for the substrate which solvent can completely dissolve a 24 mm×36 mm (80 μm in thickness) size substrate film to disappear by placing the film in a 15 cc bottle containing the solvent for 24 hours at room temperature (25° C.) and properly shaking the bottle.

Also, the solvent (S-2) which has an ability of swelling the transparent support means a solvent which, when a 24 mm×36 mm (80 μm in thickness) size substrate film is placed vertically in a 15 cc bottle containing the solvent and is kept at 25° C. for 60 seconds with proper shaking, causes bending or deformation of the substrate confirmed by observation. The film undergoes dimensional change in the swollen portion thereof, which is observed as bending or deformation. With solvents having no swelling ability, changes such as bending or deformation of the substrate are not observed.

Further, the solvent (S-3) neither dissolving nor swelling the transparent support means a solvent which does not correspond to the above-described (S-1) and (S-2).

In the case where the transparent support is a layered body having plural materials with different formulations, the solvents are judged by using the material at the outermost position of the transparent support on the side on which the hard coat layer is to be coated.

Hereinafter, solvents having dissolving ability or swelling ability are illustrated taking a triacetyl cellulose film as an example of the transparent support.

As the solvents (S-1) which dissolve the support, there are illustrated, for example, methyl formate, methyl acetate, acetone, N-methylpyrrolidone, dioxane, dioxolane, chloroform, methylene chloride, and tetrachloroethane.

As the solvents (S-2) which swell the support, there are illustrated, for example, methyl ethyl ketone (MEK), cyclohexanone, diacetonealcohol, ethyl acetate, ethyl lactate, dimethyl carbonate, and ethyl methyl carbonate.

Also, as the solvents (S-3) which neither dissolve nor swell the support, there are illustrated, for example, methyl isobutyl ketone (MiBK), toluene, and xylene.

In the invention, the mechanism how repelling upon formation of the hard coat layer is suppressed by a particular solvent formulation is not clarified, but it may be presumed that dissolution or swelling of the surface of the transparent support serves to moderate unevenness in the vicinity of the starting point of repelling.

Mixing ratio of the solvents which can be used in the invention will be described below. One preferred embodiment of the solvent which can be used in the invention is a mixture of at least one solvent selected from (S-1) and (S-2) and at least one solvent selected from (S-3). Combined use of (S-1) and (S-3) or combined use of (S-2) and (S-3) is preferred. With these mixed solutions, the proportion of (S-1) or (S-2) for the entire solvent is preferably from 20 to 90% by weight, more preferably from 30 to 80% by weight. In the embodiment of using this mixed solvent, (S-1) is preferably methyl acetate or acetone, more preferably methyl acetate. Also, (S-2) is preferably methyl ethyl ketone, cyclohexanone, ethyl acetate, dimethyl carbonate, or ethyl methyl carbonate, more preferably methyl ethyl ketone, ethyl acetate, or dimethyl carbonate.

Another preferred embodiment of the solvent which can be used in the invention is a mixture of at least one solvent selected from (S-1) and at least one solvent selected from (S-2). The ratio by weight of (S-1) to (S-2) is preferably from 90:10 to 10:90, more preferably from 80:20 to 20:80, most preferably from 30:70 to 70:30.

Also, the reason why repelling properties become worse after storing the optical substrate being to be coated thereon the hard coat layer and being in a roll up form for a long time is presumed to be that a fluorine-containing aligning aid or the like migrates from the optically anisotropic layer containing liquid crystalline compound to the surface to be coated by the fluorine-containing aligning aid, and thereby bad influence is exerted. From this viewpoint, the solvent for the hard coat layer composition is preferably a solvent which has a high solubility for the fluorine-containing aligning aid contained in the liquid crystalline compound-containing layer, and is particularly preferably methyl acetate, methyl ethyl ketone, or dimethyl carbonate.

Also, by employing the above-described solvent formulation, a gradation region can be formed between the transparent support and the hard coat layer wherein localizations of the compound components (transparent support components and hard coat layer components) gradually vary from the transparent support side to the hard coat layer side. Here, the term “hard coat layer” means a portion wherein only the hard coat components are contained and transparent support components are not contained, and the term “transparent support” means a portion which does not contain the hard coat layer components.

In view of interference unevenness, a thickness of the gradation region is preferably from 5% to 200%, more preferably from 5% to 150%, most preferably from 5% to 95%, based on a thickness of the hard coat layer.

The reason why presence of the above-described region is preferred is that interference unevenness is difficult to occur, even when differences in refractive index between the transparent support and the hard coat layer exists, due to formation of the gradation region having the above-described thickness. Another reason is that, when the thickness of the gradation region is smaller, thickness of the hard coat layer becomes larger in proportion to the reduced thickness of the gradation region, which serves to maintain good hard coat properties, such as high hardness and low curling.

Also, the gradation region can be measured as a portion where both the transparent support components and the hard coat layer components are detected by cutting the film with a microtome and analyzing the cross section by means of a time-of-flight secondary ion mass spectrometer (TOF-SIMS). The film thickness of this region can also be measured from the cross-section information of TOF-SIMS.

The total solvent amount in the composition of the invention for forming the hard coat layer is preferably in such amount that the content of solid components in the composition falls within the range of preferably from 1 to 70% by weight, more preferably from 20 to 70% by weight, still more preferably from 40 to 70% by weight, still more preferably from 45 to 65% by weight, yet more preferably from 50 to 65% by weight, most preferably from 55 to 65% by weight.

[Monomer for Forming Hard Coat Layer]

The composition for forming the hard coat layer of the invention contains a curable monomer. Preferred embodiments thereof will be described below.

A first preferred embodiment of the invention is an embodiment wherein a monomer contained in the composition for forming the hard coat layer is a mixture of (2a) and (2b) described below, and which is characterized in that the content of (2a) is more than the content of (2b).

(2a) Compound having 3 or more functional groups per molecule and having an SP value measured by Hoy method, SPa, in the range of 19<SPa<25 and a weight-average molecular weight, Mwₐ, in the range of 40<Mwₐ<1600.
(2b) Urethane compound having 3 or more functional groups per molecule and having an SP value measured by Hoy method, Spb, in the range of 19<SPb<25 and a weight-average molecular weight, Mw_{b}, in the range of 150≦|Mw_{b}−Mwₐ|≦500.

The aforesaid (2a) component to be used in the invention is a compound having 3 or more functional groups per molecule and having an SP value measured by Hoy method, SPa, in the range of 19<SPa<25 and a weight-average molecular weight, Mwₐ, in the range of 40<Mwₐ<1600.

Compounds having 3 or more functional groups per molecule like the component (2a) can function as binders and curing agents in the hard coat layer and can improve strength and scratch resistance of the coated film.

The number of the functional groups per molecule of the component (2a) is preferably from 3 to 20, more preferably from 3 to 10, still more preferably from 3 to 5, yet more preferably 3 or 4.

As the component (2a), there are illustrated compounds having a polymerizable functional group (polymerizable unsaturated double bond) such as a (meth)acryloyl group, a vinyl group, a styryl group, or an allyl group and, particularly, compounds having a (meth)acryloyl group or —C(O)OCH═CH₂ are preferred. Particularly preferably, the following compounds having 3 or more (meth)acryloyl groups per molecule can be used.

As specific examples of the compounds having polymerizable functional groups, there can be illustrated (meth)acrylic acid diesters of alkylene glycol, (meth)acrylic acid diesters of polyoxyalkylene glycol, (meth)acrylic acid diesters of polyhydric alcohol, (meth)acrylic acid diesters of ethylene oxide or propylene oxide adduct, epoxy(meth)acrylates, urethane(meth)acrylates, and polyester(meth)acrylates.

Among them, esters formed of polyhydric alcohol and (meth)acrylic acid are preferred. Examples thereof include pentaerythritol tetra(meth)acrylate, pentaerythritol tri(meth)acrylate, trimethylolpropane tri(meth)actrylate, ethylene oxide(EO)-modified trimethylolpropane tri(meth)acrylate, propylene oxide(PO)-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, urethane acrylate, polyester polyacrylate, and caprolactone-modified tris(acryloxyethyl)isocyanurate.

The weight-average molecular weight, Mwₐ, of the component (2a) is in the range of 40<Mwₐ<1600. In view of suppressing interference unevenness and improving hardness of hard coat layer due to forming the gradation region, the molecular weight is preferably in the range of 100<Mwₐ<1600, more preferably 200<Mwₐ<1600.

Additionally, the weight-average molecular weight is a weight-average molecular weight in terms of polystyrene measured by gel permeation chromatography.

SP value of the component (2a) measured by Hoy method, SPa, is in the range of 19<SPa<25. In view of suppressing interference unevenness due to forming the gradation region, SPa is preferably in the range of 19.5<SPa<24.5, more preferably 20<SPa<24.

Additionally, the SP value (solubility parameter) in the invention is a value obtained by calculating according to Hoy method. The Hoy method is described in POLYMER HANDBOOK FOURTH EDITION.

The ratio of the weight-average molecular weight Mwₐ to the number of functional groups per molecule is preferably in the range of 70<(Mwₐ/(number of functional groups per molecule)<300, more preferably 70<(Mwₐ/(number of functional groups per molecule)<290, still more preferably 70<(Mwₐ/(number of functional groups per molecule)<280. By controlling the ratio of the weight-average molecular weight Mwₐ to the number of functional groups per molecule to the above-described range, there results a high density of cross-linking groups, which serves to enhance hardness.

As the component (2a), commercially available ones may be used. For example, as polyfunctional acrylate series compounds having (meth)acryloyl groups, there can be illustrate PET30, KAYARAD DPHA, KAYARAD DPCA-30, and KAYARAD DPCA120 manufactured by Nippon Kayaku. Also, as urethane acrylate, there can be illustrated U15HA, U4HA, and A-9300 manufactured by Shin-Nakamura Chemical Co., Ltd., and EB5129 manufactured by UCB.

In order to impart sufficient polymerization ratio and sufficient hardness, the content of the component (2a) in the composition for forming the hard coat layer of the invention is preferably from 10 to 60% by weight, more preferably from 20 to 55% by weight, based on the weight of all solid components in the composition for forming the hard coat layer.

In view of suppressing interference unevenness, improving hardness, and suppressing curl, the composition for forming the hard coat layer of the invention contains the component (2a) in a larger content than the component (2b) to be described hereinafter. (Content of (2a)/content of (2b)) is >1.0, preferably (content of (2a)/content of (2b)) is >2.0, more preferably (content of (2a)/content of (2b)) is >3.5.

[Urethane Compound (2b) Having 3 or More Functional Groups Per Molecule]

The aforesaid component (2b) contained in the composition for forming the hard coat layer of the invention will be described below.

The component (2b) to be used in the invention is a compound having 3 or more functional groups per molecule and having an SP value measured by Hoy method, SPb, in the range of 19<SPb<25 and a weight-average molecular weight, Mw_{b}, in the range of 150≦|Mw_{b}−Mwₐ|≦500.

The component (2b) is a compound with which the absolute value of the difference in weight-average molecular weight between the component (2a) and the component (2b) is from 150 to 500. Since the component (2a) and the component (2b) are different from each other in weight-average molecular weight with the above-described particular range, they are different from each other in permeability into the transparent support. Thus, a gradation region is formed between the transparent support and the hard coat layer to thereby suppress interference unevenness. Also, the component (2b) is a compound having 3 or more functional groups per molecule, can function as a binder and a curing agent for the hard coat layer, and can improve strength and scratch resistance of the coated film.

The polymerizable functional groups which the component (2b) has, and specific examples and commercially available products of the component (2b) are similar to those which are described with respect to the aforesaid component (2a).

In the composition for forming the hard coat layer of the invention, the component (2b) is a urethane compound. The urethane compound is preferably a compound having 2 urethane bonds. It is also preferred for the urethane compound to have a (meth)acryloyl group, with polyurethane polyacrylate being more preferred.

The weight-average molecular weight, Mw_{b}, of the component (2b) is different in absolute value from the weight-average molecular weight, Mwₐ, of the component (2a) with a difference in the range of 150≦|Mw_{b}−Mwₐ|≦500. In view of suppressing interference unevenness and improving hardness of hard coat layer due to forming the gradation region, the difference in absolute value is preferably in the range of 150≦|Mw_{b}−Mwₐ|≦450, more preferably 200≦|Mw_{b}−Mwₐ|≦450.

Additionally, the weight-average molecular weight is a weight-average molecular weight in terms of polystyrene measured by gel permeation chromatography.

When the above-described difference in molecular weight exists, two monomer localizations different in a certain level from each other, in which the localization curve is not smoothly changed in the film depth direction. The two monomers have good affinity for the transparent support and are so compatible with each other that the localization of the monomers and the transparent support as an entire film smoothly changes (which means that refractive index continuously changes in the film thickness direction), thus a gradation layer wherein refractive index changes continuously being formed and interference unevenness being suppressed. However, in case when the difference in molecular weight is larger or smaller than that described above, the continuous change of the monomer localization as an entire film disappears.

SP value of the component (2b) measured by Hoy method, SPb, is in the range of 19<SPb<25. In view of suppressing interference unevenness by forming the gradation region, SPb is preferably in the range of 19.5<SPb<24.5, more preferably 20<SPb<24.5.

Additionally, the SP value (solubility parameter) in the invention is a value obtained by calculating according to Hoy method. The Hoy method is described in POLYMER HANDBOOK FOURTH EDITION.

The ratio of the weight-average molecular weight Mw_{b} of the component (2b) to the number of functional groups per molecule is preferably in the range of 70<(Mw_{b}/(number of functional groups per molecule)<300, more preferably 70<(Mw_{b}/(number of functional groups per molecule)<290, still more preferably 70<(Mw_{b}/(number of functional groups per molecule)<280. By controlling the ratio of the weight-average molecular weight Mw_{b} to the number of functional groups per molecule to the above-described range, there results a high density of cross-linking groups, which serves to enhance hardness.

In order to impart sufficient polymerization ratio and sufficient hardness, the content of the component (2b) in the composition for forming the hard coat layer of the invention is preferably from 5.0 to 30% by weight, more preferably from 5.0 to 15% by weight, based on the weight of all solid components in the composition for forming the hard coat layer. Also, the ratio of the content of the component (2a) to the content of the component (2b) in the composition for forming the hard coat layer is the same as described hereinbefore.

A second preferred embodiment of the monomer for the hard coat layer of the invention is a mixture of (1a) and (1b) described below, and which is characterized in that the content ratio of (1a) to (1b) is 0.5% by weight to 10% by weight.

(1a) Compound having 2 or less functional groups per molecule and having a weight-average molecular weight, Mwₐ, in the range of 40<Mwₐ<500 and an SP value measured by Hoy method, SPa, in the range of 19<SPa<24.5.
(1b) Compound having 3 or more functional groups per molecule and having a weight-average molecular weight, Mw_{b}, in the range of 100<Mw_{b}<1600 and an SP value measured by Hoy method, SPb, in the range of 19<SPb<24.5, with 70<(Mw_{b}/(number of functional groups per molecule))<300.

[Compound (1a) Having 2 or Less Functional Groups Per Molecule]

Compounds (1a) to be contained in the composition for forming the hard coat layer of the invention which have 2 or less functional groups per molecule are compounds having a weight-average molecular weight, Mwₐ, in the range of 40<Mwₐ<500 and an SP value measured by Hoy method, SPa, in the range of 19<SPa<24.5. Compounds having such molecular weight and SP value are easily permeable into the transparent support, and are preferred for forming a gradation region between the transparent support and the hard coat layer. Also, since the number of functional groups is 2 or less, contraction of the compounds (1a) in curing is small and the compounds (1a) does not cause curling when cured after permeation into the transparent support.

The number of functional groups per molecule is preferably 1 or 2, more preferably 1.

As the compounds having 2 or less functional groups per molecule, there are illustrated compounds having a polymerizable functional group (polymerizable unsaturated double bond) such as a (meth)acryloyl group, a vinyl group, a styryl group, or an allyl group and, particularly, compounds having a (meth)acryloyl group or —C(O)OCH═CH₂ are preferred.

Specific examples of the compounds (1a) having 2 or less functional groups per molecule include:

(meth)acrylic acid diesters such as neopentyl glycol diacrylate, 1,6-hexanediol di(meth)acrylate, ethylene glycol di(meth)acrylate, and propylene glycol di(meth)acrylate;
polyoxyalkylene glycol (meth)acrylic acid diesters such as polyethylene glycol di(meth)acrylate having 8 or less number of repeating ethylene units (e.g., diethylene glycol di(meth)acrylate or triethylene glycol di(meth)acrylate) and polypropylene glycol di(meth)acrylate having 6 or less number of repeating propylene units (e.g., dipropylene glycol di(meth)acrylate or tripropylene glycol di(meth)acrylate);
(meth)acrylic acid diesters of polyhydric alcohols such as pentaerythritol di(meth)acrylate, 1,4-cyclohexane diacrylate, and tricyclodecanedimethanol di(meth)acrylate;
(metha)acrylic acid diesters of ethylene oxide adduct such as 2,2-bis{4-(methacryloxy.ethoxy)phenyl}propane and 2,2-bis{4-acryloxy.diethoxy}phenyl}propane; and monofunctional (meth)acrylic acid esters such as isobornyl(meth)acrylate, octyl methacrylate, decyl(meth)acrylate, aliphatic epoxy(meth)acrylate, ethoxylated phenyl(meth)acrylate, β-carboxyethyl(meth)acrylate, methoxypolyethylene glycol(meth)acrylate, phenoxypolyethylene glycol(meth)acrylate, 2-(meth)acryloyloxyethyl succinate, glycerin mono(meth)acrylate, 2-hydroxyethyl(meth)acrylate, cyclohexyl(meth)acrylate, and lauryl(meth)acrylate.

Weight-average molecular weight of compounds (1a), Mwₐ, having 2 or less functional groups per molecule be in the range of 40<Mwₐ<500. In view of suppressing interference unevenness by forming the gradation region, the molecular weight is preferably in the range of 40<Mwₐ<400, more preferably 40<Mwₐ<200.

Additionally, the weight-average molecular weight is a weight-average molecular weight in terms of polystyrene measured by gel permeation chromatography.

SP value of the compounds (1a) having 2 or more functional group per molecule measured by Hoy method, SPa, is in the range of 19<SPa<24.5. In view of suppressing interference unevenness by forming the gradation region, SPa is preferably in the range of 19.5<SPa<24.5, more preferably 20<SPa<24.5.

Additionally, the SP value (solubility parameter) in the invention is a value obtained by calculating according to Hoy method. The Hoy method is described in POLYMER HANDBOOK FOURTH EDITION.

As the compounds having 2 or less functional groups per molecule, commercially available ones may also be used, and examples thereof include BLEMMER E, BLEMMER PE-90, BLEMMER GMR, BLEMMER PME-100, BLEMMER PME-200, BLEMMER PME-400, BLEMMER PDE-200, and BLEMMER PDE-400 manufactured by NOF CORPORATION; ABE10, ABE300, A-200, and A-400 manufactured by Shin-Nakamura Chemical Co., Ltd.; Viscoat #195 manufactured by OSAKA ORGANIC CHEMICAL INDUSTRY LTD.; and EB4858 manufactured by DAICEL CHEMICAL INDUSTRIES LTD.

The content of the compound (1a) having 2 or less functional groups per molecule and being contained in the composition for forming the hard coat layer of the invention be from 0.5% by weight to 10% by weight based on the weight of the polyfunctional materials contained in the hard coat composition. The content is more preferably from 0.5 to 9% by weight, still more preferably from 0.5 to 8% by weight. Curling properties can markedly be reduced by increasing the addition amount of (1a), whereas addition of the compound in a too much amount can reduce the pencil hardness. Thus, in view of employing a region where curling properties are reduced and, at the same time, good hardness is obtained, the addition amount is preferably in the range described hereinbefore.

However, the optimal range of the above-described addition amount may be deviated by ±5% depending upon whether the compound is a monofunctional compound or a bifunctional compound. This is because curling-reducing effect of the monofunctional compound used as (1a) is greater than that of the bifunctional compound used as (1a).

[Compound (1b) Having 3 or More Functional Groups]

Next, compounds (1b) having 3 or more functional groups per molecule and being contained in the composition for forming the hard coat layer of the invention will be described below.

Compounds (1b) having 3 or more functional groups per molecule are compounds and having a weight-average molecular weight, Mw_{b}, in the range of 100<Mw_{b}<1600 and an SP value measured by Hoy method, SPb, in the range of 19<SPb<24.5, with 70<(Mw_{b}/(number of functional groups per molecule))<300. Compounds having such molecular weight and SP value are less permeable into the transparent support in comparison with the compounds (1a) having 2 or less functional groups per molecule, but have such a good compatibility that, when used in combination with the above-described compound (1a), they can form the gradation region and substantially remove refractive index interface between the gradation layer and the hard coat layer.

Also, compounds (1b) having 3 or more functional groups per molecule can function as binders and curing agents in the hard coat layer and can improve strength and scratch resistance of the coated film.

The number of the functional groups per molecule of the compound (1b) is preferably from 3 to 20, more preferably from 3 to 10, still more preferably from 3 to 5.

It is also preferred to use, in combination, two or more of the compounds (1b) having 3 or more functional groups per molecule in the composition for forming the hard coat layer of the invention.

As the compound (1b) having 3 or more functional groups per molecule, there are illustrated compounds having a polymerizable functional group (polymerizable unsaturated double bond) such as (meth)acryloyl group, a vinyl group, a styryl group, or an allyl group and, particularly, compounds having a (meth)acryloyl group or —C(O)OCH═CH₂ are preferred. Particularly preferably, the following compounds having 3 or more (meth)acryloyl groups can be used.

As specific examples of the compounds having polymerizable functional groups, there can be illustrated (meth)acrylic acid diesters of alkylene glycol, (meth)acrylic acid diesters of polyoxyalkylene glycol, (meth)acrylic acid diesters of polyhydric alcohol, (meth)acrylic acid diesters of ethylene oxide or propylene oxide adduct, epoxy(meth)acrylates, urethane(meth)acrylates, and polyester(meth)acrylates.

Among them, esters between polyhydric alcohol and (meth)acrylic acid are preferred. Examples thereof include pentaerythritol tetra(meth)acrylate, pentaerythritol tri(meth)acrylate, trimethylolpropane tri(meth)actrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl)isocyanurate.

The weight-average molecular weight, Mw_{b}, of the compound (1b) having 3 or more functional groups per molecule be in the range of 100<Mw_{b}<1600. In view of suppressing interference unevenness and improving hardness of hard coat layer by forming the gradation region, the molecular weight is preferably in the range of 200<Mw_{b}<1600.

Additionally, the weight-average molecular weight is a weight-average molecular weight in terms of polystyrene measured by gel permeation chromatography.

SP value of the compound (1b) having 3 or more functional groups per molecule measured by Hoy method, SPa, is in the range of 19<SPa<24.5. In view of suppressing interference unevenness by forming the gradation region, SPa is preferably in the range of 19.5<SPa<24.5, more preferably 20<SPa<24.5.

Additionally, the SP value (solubility parameter) in the invention is a value obtained by calculating according to Hoy method. The Hoy method is described in POLYMER HANDBOOK FOURTH EDITION.

The ratio of the weight-average molecular weight Mw_{b} to the number of functional groups per molecule is preferably in the range of 70<(Mw_{b}/(number of functional groups per molecule)<300, more preferably 70<(Mw_{b}/(number of functional groups per molecule)<290, still more preferably 70<(Mw_{b}/(number of functional groups per molecule)<280. By controlling the ratio of the weight-average molecular weight Mw_{b} to the number of functional groups per molecule to the above-described range, there results a high density of cross-linking groups, which serves to enhance hardness.

Additionally, in the case of using 2 or more kinds of the compounds (1b) having 3 or more functional groups per molecule in combination, it is preferred that the average value of the ratios of (Mw_{b}/(number of functional groups per molecule)) is within the above-described range.

As the compounds (1b), commercially available ones may be used. For example, as polyfunctional acrylate series compounds having (meth)acryloyl groups, there can be illustrate KAYARAD DPHA, KAYARAD DPCA-30, and KAYARAD PET30 manufactured by Nippon Kayaku. Also, as polyurethane polyacrylate, there can be illustrated 15HA, U4HA, UA306H, and EB5129 manufactured by Shin-Nakamura Chemical Co., Ltd.

In order to impart sufficient polymerization ratio and sufficient hardness, the content of the compound (1b) having 3 or more functional groups per molecule in the composition for forming the hard coat layer of the invention is preferably from 40 to 70% by weight, more preferably from 45 to 65% by weight, still more preferably from 50 to 65% by weight, most preferably from 55 to 65% by weight, based on the weight of all solid components in the composition for forming the hard coat layer.

A third preferred embodiment of the monomer for the hard coat layer of the invention is characterized in that at least part of the monomer contained in the composition for forming the hard coat layer is following (Aa): (Aa) a polyethylene oxide compound having 1 or more photo-polymerizable group and having a structure of —(CH₂CH₂O)ₙ—, wherein n represents a number of 1 to 50.

[Polyethylene Oxide Compound (Aa)]

The aforesaid polyethylene oxide compound (Aa) contained in the composition for forming the hard coat layer of the invention and having 1 or more photo-polymerizable groups and a structure of —(CH₂CH₂O)ₙ—, wherein n represents a number of 1 to 50, will be described.

Polyethylene oxide compounds (Aa) have 1 or more photo-polymerizable groups and have a structure of —(CH₂CH₂O)ₙ—, wherein n represents a number of 1 to 50.

In view of suppressing bleed-out and not reducing hardness of the hard coat layer, the number of the photo-polymerizable groups which the polyethylene oxide compound (Aa) has is preferably from 10 to 2000 g·mol⁻¹, more preferably from 50 to 1000 g·mol⁻¹, still more preferably from 100 to 500 g·mol⁻¹, in terms of weight per functional group equivalent. As more specific number of the functional groups, a number of from 1 to 18 is preferred, 2 or 3 is more preferred, and 2 is still more preferred.

As the photo-polymerizable group which the polyethylene oxide compound (Aa) has, there are illustrated a (meth)acryloyl group, a (meth)acryloyloxy group, a vinyl group, or an allyl group. In view of good reactivity with other compound having an unsaturated double bond, a (meth)acryloyloxy group is preferred, with an acryloyloxy group being more preferred.

In the polyethylene oxide compound (Aa), n represents a number of repeating units, and is a number of from 1 to 50. n is preferably from 1 to 30, more preferably from 3 to 20.

In particular, in the case where the polyethylene oxide compound (Aa) has 2 photo-polymerizable groups, n is preferably from 1 to 20, more preferably from 3 to 15. In the case where the polyethylene oxide compound (Aa) has 2 photo-polymerizable groups, hardness of the hard coat layer is improved when n is 20 or less, thus such n being preferred. Also, n is preferably 1 or more because of excellent curling reduction.

Also, in the case where the polyethylene oxide compound (Aa) has 3 photo-polymerizable groups, n is preferably from 1 to 30, more preferably from 5 to 20. This may be attributed to that, since cross-linking density becomes higher than in the case where n is 2, the optimal value of the ethylene oxide chain shifts to a longer side in order to reduce curling.

Regarding the number of the —(CH₂CH₂O)ₙ— structure contained in the polyethylene oxide compound (Aa), a smaller number is preferred in that, to compare in terms of the total number of —(CH₂CH₂O)— structure contained in one molecule, a longer polyethylene oxide chain is more advantageous for reducing curling. Thus, the number is more preferably 6 or less, still more preferably 4 or less, particularly preferably 1.

Molecular weight of the polyethylene oxide compound (Aa) is preferably 1000 or less. When the molecular weight is 1000 or less, hardness of the hard coat layer is improved, and the curling-reducing effect is large, thus such molecular weight being preferred. This may be attributed to that, when the molecular weight of the polyethylene oxide compound (Aa) is 1000 or less, such polyethylene oxide compounds (Aa) are difficult to gather on the surface of the transparent support.

The polyethylene oxide compound (Aa) contains a photo-polymerizable group and a structure of —(CH₂CH₂O)ₙ—, and may have other structure than these structures. Examples of such structure include alkylene, amido bond, sulfonylamido bond, thioamido bond, ether bond, ester bond, and urethane bond.

The polyethylene oxide compound (Aa) preferably is the photo-polymerizable group and the structure of —(CH₂CH₂O)ₙ—, because the curling-reducing effect can be obtained most easily.

The polyethylene oxide compound (Aa) may have a branched or straight structure. However, to compare a compound having a straight structure and (CH₂CH₂O) structures per molecule and another compound having a branched structure where the number of (CH₂CH₂O) structures per molecule is the same as the compound having a straight structure, the compound having a straight structure can more advantageously reduce curling while the branched carbon moiety has no curling-reducing effect. In view of this point, the compound preferably has a straight structure.

A particularly preferred structure of the polyethylene oxide compound (Aa) is the structure wherein photo-polymerizable groups are bonded to each of both ends of one —(CH₂CH₂O)ₙ— structure, and a compound represented by the following general formula (a1) is preferred.

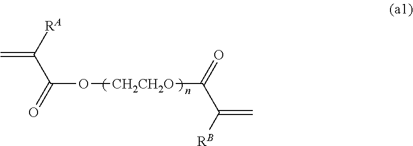

In the above formula, each of R^{A} and R^{B} independently represents a hydrogen atom or a methyl group. n and a preferred range thereof are the same as defined hereinbefore. In particular, a compound wherein n is approximately 9 is most preferred.

Specific examples of the polyethylene oxide compound (Aa) are shown below, but the present invention is not limited thereto. Additionally, ethylene oxide is abbreviated as “EO”.

EO adduct of trimethylolpropane tri(meth)acrylate

EO adduct of pentaerythritol tetra(meth)acrylate

EO adduct of dimethylolpropane tetra(meth)acrylate

EO adduct of dipentaerythritol penta(meth)acrylate

EO adduct of dipentaerythritol hexa(meth)acrylate

Tris(2-hydroxyethyl)isocyanurate tri(meth)acrylate

EO-modified diglycerin tetra-acrylate

The polyethylene oxide compound (Aa) can be synthesized by processes described in, for example, JP-A-2001-172307 and Japanese Patent No. 4,506,237. Also, as the polyethylene oxide compound (Aa), commercially available ones may also be used. As preferred examples of such commercially available products, there are illustrated “A-400” manufactured by Shin-Nakamura Chemical Co., Ltd., “BLEMMER PP-500” and “BLEMMER PME-1000” manufactured by NOF CORPORATION, “Viscoat #360” manufactured by OSAKA ORGANIC CHEMICAL INDUSTRY LTD., and “DGE-4A” manufactured by Kyoeisha Chemical Co., Ltd.

In view of obtaining excellent curling-reducing effect with not reducing hardness of the hard coat layer, the content of the polyethylene oxide compound (Aa) in the composition for forming the hard coat layer of the invention is preferably from 1% by weight to 40% by weight, more preferably from 3% by weight to 30% by weight, still more preferably from 5% by weight to 20% by weight, based on the weight of all solid components in the composition for forming the hard coat layer.

[Photo-Polymerization Initiator (d)]

It is preferred that a photo-polymerization initiator (d) is contained in the composition for forming the hard coat layer of the invention.

Examples of the photo-polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins. Specific examples, preferred embodiments, commercially available products and the like of the photo-polymerization initiator are described in paragraphs [0133] to [0151] of JP-A-2009-098658, and the same can also be applied in the invention.

In addition, examples of various photo-polymerization initiators are described in Saishin UV Koka Gijutsu, p. 159, K.K. Gijutsu Joho Kyokai (1991), and Kato Kiyomi, Shigaisen Koka Shisutemu, pp. 65-148, Sogo Gijutsu Senta (1989), and they are useful for the invention.

For the reason of incorporating the photo-polymerization initiator in a sufficiently large amount to polymerize the polymerizable compound contained in the composition for forming the hard coat layer and in a sufficiently small amount not to increase the number of initiation points too much, the content of the photo-polymerization initiator in the composition for forming the hard coat layer of the invention is preferably from 0.5 to 8% by weight, more preferably from 1 to 5% by weight, based on the weight of all solid components in the composition for forming the hard coat layer.

[Leveling Agent (e)]

Leveling agents (e) which may be contained in the composition for forming the hard coat layer in accordance with the invention will be described below.

The leveling agent is preferably at least one selected from either of the following fluorine-containing polymer (1) and the fluorine-containing polymer (2).

The fluorine-containing polymer (1) is a polymer containing a polymerization unit derived from a fluoro-aliphatic group-containing monomer represented by the following general formula [1] in a content more than 50% by weight based on all of the polymerization units.

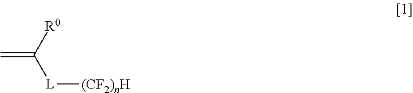

In the above general formula [1], R⁰ represents a hydrogen atom, a halogen atom, or a methyl group, L represents a divalent linking group, and n represents an integer of from 1 to 18.

In the fluorine-containing polymer (1), the content of the repeating unit derived from the fluoro-aliphatic group-containing monomer represented by the general formula [1] exceeds 50% by weight based on all polymerization units constituting the fluorine-containing polymer (1), and is preferably 70% by weight or more, more preferably 80% by weight or more.

In the general formula [1], R⁰ represents a hydrogen atom, a halogen atom, or a methyl group, preferably a hydrogen atom or a methyl group.

n represents an integer of from 1 to 18, more preferably from 4 to 12, still more preferably from 6 to 8, most preferably 8.

Also, two or more kinds of the fluoro-aliphatic group-containing monomer represented by the general formula [1] may be contained as structural units in the fluorine-containing polymer (1).

In the fluorine-containing polymer (1), the general formula [1] is preferably the following general formula [1-2].

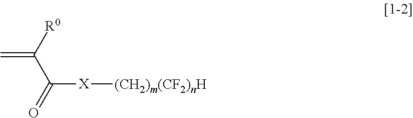

In the above general formula [1-2], R⁰ represents a hydrogen atom, a halogen atom, or a methyl group, X represents an oxygen atom, a sulfur atom, or —N(R²)—, m represents an integer of 1 to 6, and n represents an integer of from 1 to 18. Here, R² represents a hydrogen atom or an alkyl group containing from 1 to 8 carbon atoms which may have a substituent.

In the general formula [1-2], R⁰ represents a hydrogen atom, a halogen atom, or a methyl group, preferably a hydrogen atom or a methyl group.

X represents an oxygen atom, a sulfur atom, or —N(R²)—, more preferably an oxygen atom or —N(R²)—, still more preferably an oxygen atom. R² represents a hydrogen atom or an alkyl group containing from 1 to 8 carbon atoms which may have a substituent and, as the substituent, there are illustrated, for example, a phenyl group, a benzyl group, or an ether oxygen. R² represents more preferably a hydrogen atom or an alkyl group containing from 1 to 4 carbon atoms which may have a substituent, more preferably a hydrogen atom or a methyl group.

m represents an integer of from 1 to 6, more preferably from 1 to 3, still more preferably 1.

n represents an integer of from 1 to 18, more preferably from 4 to 12, still more preferably from 6 to 8, most preferably 8.

Two or more kinds of the fluoro-aliphatic group-containing monomer represented by the general formula [1-2] may be contained as structural units in the fluorine-containing polymer (1).

Next, fluorine-containing polymers (2) will be described.

The fluorine-containing polymer (2) is a polymer which contains a polymerization unit derived from a fluorine-containing aliphatic group-containing monomer represented by the following general formula [2] and a polymerization unit derived from either of poly(oxyalkylene)acrylate and poly(oxyalkylene)methacrylate.

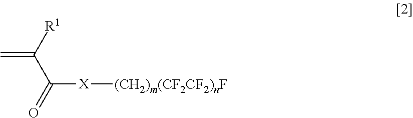

In the above general formula [2], R¹ represents a hydrogen atom or a methyl group, X represents an oxygen atom, a sulfur atom, or —N(R²)—, m represents an integer of from 1 to 6, and n represents an integer of from 1 to 3. R² represents a hydrogen atom or an alkyl group containing from 1 to 4 carbon atoms.

One of the fluoro-aliphatic groups in the fluorine-containing polymer (2) is preferably derived from a fluoro-aliphatic compound prepared by a telomerization method (occasionally referred to as telomer method) or an oligomemerization (occasionally referred to as oligomer method). Examples of preparation of the fluorine-containing aliphatic compound are described on pages 117 to 118 in Synthesis and Function of Fluoride Compounds (Fussokagoubutsu no Gousei to Kinou) overseen by ISHIKAWA NOBUO and published by CMC Publishing Co., Ltd. in 1987; and on pages 747 to 752 in Chemistry of Organic Fluorine Compounds II, Monograph 187, Ed by Milos Hudlicky and Attila E. Pavlath, American Chemical Society 1995; and the like.

As the above-described fluoro-aliphatic group-containing monomers [1] and [2], and fluorine-containing polymers (1) and (2), there can be illustrated those specific examples which are described in JP-A-2010-1549434, JP-A-2010-121137, JP-A-2004-331812, and JP-A-2004-163610. However, the invention is not limited by them.

Also, as the leveling agent, the fluoro-aliphatic group-containing polymers described in Japanese Patent 4,474,114 are also preferred. Fluoro-aliphatic group-containing polymers different from the fluoro-aliphatic group-containing polymers described in Japanese Patent 4,474,114 in that the ratio of fluoro-aliphatic group-containing polymerization unit is in the range of from 50 to 70% can also be used as the leveling agents.

It is also possible to use a silicone series compound as a leveling agent. As the silicone series compound, modified silicones are preferred. Examples of functional groups to be used for modification include a polyether group, a polyurethane group, an epoxy group, a carboxyl group, a (meth)acrylate group, a carbinol group, a hydroxyl group, an alkyl group, an aryl group, and an alkylene oxide group.

In the invention, the leveling agent is preferably aligned on the surface of the hard coat layer in a sufficient amount for removing coating unevenness of the hard coat layer. However, when the leveling agent contained in the hard coat layer remains at the interface between the hard coat layer and an antireflection layer upon providing the antireflection layer on the hard coat layer, adhesion is deteriorated, and scratch resistance is seriously spoiled. Therefore, it becomes important for the leveling agent to be rapidly extracted into the antireflection layer upon providing the antireflection layer on the hard coat layer and not to remain at the interface. Since the fluorine-containing polymer (1) has a hydrogen atom at a terminal group thereof, the fluorine-containing polymer (1) less repels the upper layer coating liquid than the fluorine-containing polymer (2) which has a fluorine atom at a terminal group. As a result, the polymer (1) is rapidly extracted by the upper layer and scarcely remains at the interface between the antireflection layer and the hard coat layer. Thus, the fluorine-containing polymer (1) is more preferred.

For the reason of imparting sufficient leveling properties to reduce coating unevenness and, at the same time, selecting the amount at a sufficiently low level not to remain at the interface between the hard coat layer and other layer, the content of the leveling agent in the composition for forming the hard coat layer of the invention is preferably from 0.0005% by weight to 2.5% by weight, more preferably from 0.005% to 0.5% by weight, based on the weight of all solid components in the composition for forming the hard coat layer.

[Conductive Compound (e)]

The optical film hard coat layer of the invention may contain a conductive compound for the purpose of imparting antistatic properties. In particular, use of a conductive compound having hydrophilicity can improve surface-localization properties of the leveling agent and can prevent planar unevenness and more improve scratch resistance. In order to impart hydrophilicity to the conductive compound, a hydrophilic group may be introduced into the conductive compound. As such hydrophilic group, those which have a cationic group are preferred in view of realizing high conductivity and being relatively inexpensive. Of them, those which have a quaternary ammonium base are more preferred.

The conductive compound to be used in the invention is not particularly limited, and examples thereof include ion-conducting compounds and electron-conducting compounds. Examples of an ion-conducting compound include cationic, anionic, nonionic, and amphoteric ion-conducting compounds. Examples of an electron-conducting compound include non-conjugated or conjugated macromolecular electron-conducting compounds which each contain aromatic carbon or heterocyclic rings interlinked with one another via single bonds or di- or higher-valent linking groups. Of these conductive compounds, compounds having quaternary ammonium bases (cationic compounds) are preferred over the others in terms of high antistatic power, relatively inexpensive and localization to the transparent support-side region.

Although the compounds having quaternary ammonium bases may be either those of low molecular type or those of high molecular type, cationic antistatic agents of high molecular type are preferably used because they don't cause changes in antistatic properties by bleed-out or so on. As the quaternary ammonium base-containing cationic compounds of high molecular type, those selected from known compounds as appropriate can be used. In view of localization to the transparent support-side region, however, polymers which each have at least one of structural units represented by the following general formulae (I) to (III) are preferred.

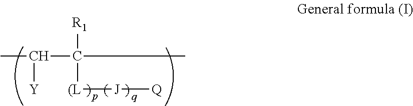

In the general formula (I), R₁ represents a hydrogen atom, an alkyl group, a halogen atom, or —CH₂COO⁻M⁺, Y represents a hydrogen atom or —COO⁻M⁺, M⁺represents a proton or a cation, L represents —CONH—, —COO—, —CO— or —O—, J represents an alkylene group, an arylene group, or a group composed of the combination thereof, and Q represents one selected from the following group A.

### A:

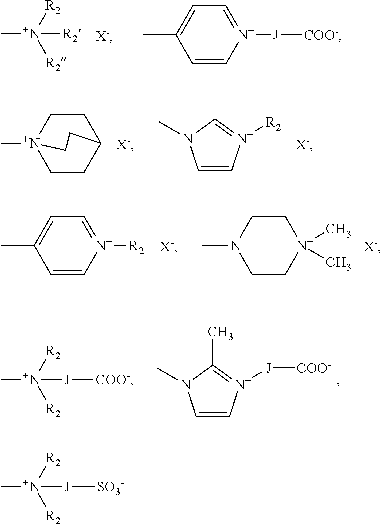

In the above formulae, each of R₂s, R₂′, and R₂″ independently represents an alkyl group, each of Js represents an alkylene group, an arylene group, or a group composed of the combination thereof, and each X⁻ represents an anion. p and q each independently represents 0 or 1.

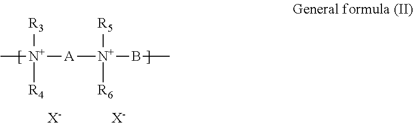

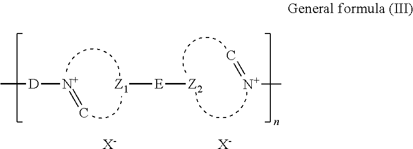

In the general formulae (II) and (III), each of R₃, R₄, R₅, and R₆ independently represents an alkyl group, or each of the R₃-R₄ pair and the R₅-R₆ pair may form a bond and complete a nitrogen-containing heterocyclic ring, each of A, B, and D independently represents an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, or —R₂₃NHCONHR₂₄NHCONHR₂₅—, E represents a single bond, an alkylene group, an arylene group, an alkenylene group, an arylenealkylene group, —R₇COR₈—, —R₉COOR₁₀OCOR_{H}—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅—, or —NHCOR₂₆CONH—, each of R₇, R₈, R₉, R₁₁, R₁₂, R₁₄, R₁₅, R₁₆, R₁₇, R₁₉, R₂₀, R₂₂, R₂₃, R₂₅, and R₂₆ represents an alkylene group, each of R₁₀, R₁₃, R₁₈, R₂₁, and R₂₄ independently represents a linking group selected from the group consisting of an alkylene group, an alkenylene group, an arylene group, an arylenealkylene group, and an alkylenearylene group, m represents a positive integer of 1 to 4, X⁻ represents an anion, each of Z₁ and Z₂ represents nonmetal atoms required for completing a 5- or 6-membered ring together with the group —N═C—, which may link with E in the form of a quaternary salt ≡N⁺[X⁻]—, and n represents an integer of from 5 to 300.

Substituents in the formulae (I) to (III) will be described below.

The halogen atom is a chlorine atom or a bromine atom, preferably a chlorine atom. The alkyl group is preferably a branched or straight-chain alkyl group containing from 1 to 4 carbon atoms, more preferably a methyl group, an ethyl group, or a propyl group. The alkylene group is preferably an alkylene group containing from 1 to 12 carbon atoms, more preferably a methylene group, an ethylene group, or a propylene group, particularly preferably an ethylene group. The arylene group is preferably an arylene group containing from 6 to 15 carbon atoms, more preferably a phenylene group, a diphenylene group, a phenylmethylene group, a phenyldimethylene group, or a naphthylene group, particularly preferably a phenylmethylene group. These groups may have substituents. The alkenylene group is preferably an alkenylene group containing from 2 to 10 carbon atoms, and the arylenealkylene group is preferably an arylenealkylene group containing from 6 to 12 carbon atoms. These groups may have substituents. Examples of a substituent the foregoing groups each may have include a methyl group, an ethyl group, and a propyl group.

In the formula (I), R₁ is preferably a hydrogen atom, Y is preferably a hydrogen atom, J is preferably a phenylmethylene group, Q is preferably a group selected from the class A and represented by the following general formula (VI) wherein each of R₂, R₂′ and R₂″ is a methyl group, X⁻ is e.g. a halide ion, a sulfonate anion, or a carboxylate anion, preferably a halide ion, more preferably a chloride ion, and p and q each is preferably 0 or 1, and the case of p=0 and q=1 is more preferred.

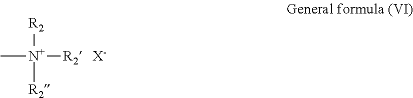

In the general formulae (II) and (III), R₃, R₄, R₅, and R₆ each is preferably a substituted or unsubstituted alkyl group containing from 1 to 4 carbon atoms, more preferably a methyl group or an ethyl group, particularly preferably a methyl group, each of A, B, and D independently represents preferably a substituted or unsubstituted alkylene, arylene, alkenylene or arylenealkylene group containing 2 to 10 carbon atoms, more preferably a phenyldimethylene group, X⁻ is, for example, a halide ion, a sulfonate anion, or a carboxylate anion, preferably a halide ion, more preferably a chloride ion, E is preferably a single bond, an alkylene group, an arylene group, an alkenylene group, or an arylenealkylene group, and an example of the 5- or 6-membered ring each of Z₁ and Z₂ forms together with the group —N═C— is a diazoniabicyclooctane ring.

Specific examples of a compound having structural units represented by the formula (I), (II) or (III) are illustrated below, but the invention should not be construed as being limited by these examples. Additionally, among the subscripts (m, x, y, z, r and real numeric values) in the following examples, m stands for the number of repetitions of each unit, and x, y, z and r stand for mole fractions of the units concerned, respectively.

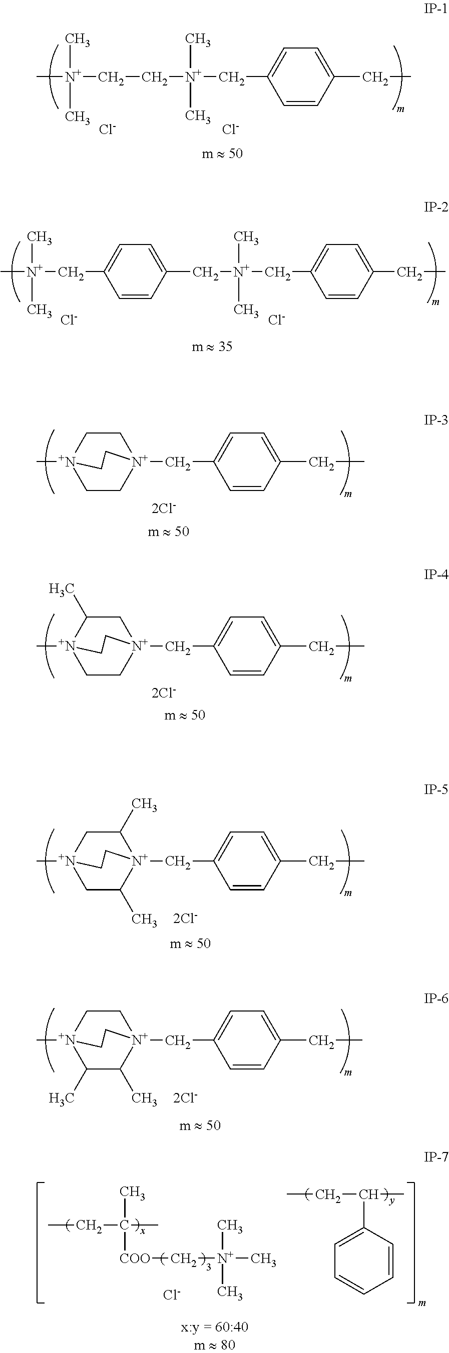

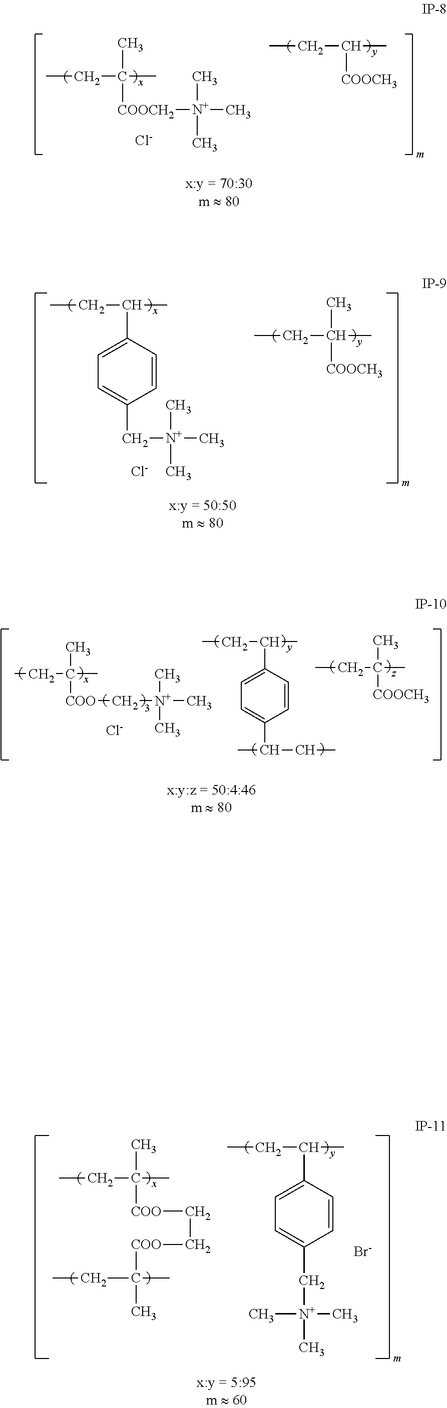

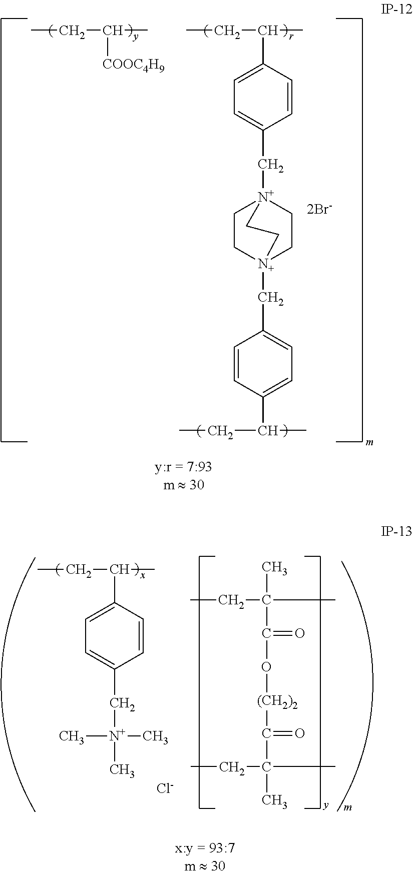

The conductive compounds illustrated above may be used alone, or can be used as combinations of two or more thereof. In addition, antistatic compounds having polymerizable groups within molecules of antistatic agents are more preferred because they can also enhance scratch resistance (film strength) of the antistatic layer.

Electron-conducting compounds are preferably non-conjugated or conjugated high polymers in each of which aromatic a carbon or heterocyclic ring are interlinked with another carbon or heterocyclic ring via single bonds or di- or higher-valent linkage groups. An example of the aromatic carbon rings in each non-conjugated or conjugated high polymer is a benzene ring, and the benzene ring may further form a fused ring. Examples of the aromatic heterocyclic rings in each non-conjugated or conjugated high polymer include a pyridine ring, a pyrazine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, a benzimidazole ring, and an imidazopyridine ring. These rings each may further form a fused ring, and may have a substituent.

Examples of the di- or higher-valent linking groups in each non-conjugated or conjugated high polymer include linking groups formed by carbon atoms, silicon atoms, nitrogen atoms, boron atoms, oxygen atoms, sulfur atoms, metals, metal ions, or the like, preferably groups formed by carbon atoms, nitrogen atoms, silicon atoms, boron atoms, oxygen atoms, sulfur atoms, or combinations of these atoms. Examples of groups formed by the combinations include a substituted or unsubstituted methylene group, a carbonyl group, an imino group, a sulfonyl group, a sulfinyl group, an ester group, an amido group, and a silyl group.

Specific examples of such an electron-conducting compound include substituted or unsubstituted conductive polyaniline, poly(p-phenylene), poly(p-phenylenevinylene), polythiophene, polyfuran, polypyrrole, polyselenophene, polyisothianaphthene, polyphenylene sulfide, polyacetylene, polypyridylvinylene, polyazine, and derivatives of these polymers. These high molecular compounds may be used alone, or as combinations of two or more thereof in response to the purposes of using them.

Those conductive polymers may be used as mixtures with polymers having no conductivity so long as the mixtures can attain the intended conductivity. Alternatively, copolymers of monomers capable forming conductive polymers and other monomers having no conductivity may be used.

It is more preferred that the electron-conducting compounds are conjugated high polymers. Examples of a conjugated high polymer include polyacetylene, polydiacetylene, poly(p-phenylene), polyfluorene, polyazurene, poly(p-phenylene sulfide), polypyrrole, polythiphene, polyisothianaphthene, polyaniline, poly(p-phenylenevinylene), poly(2,5-thienylenevinylene), double-chain conjugated high polymers (such as polyperinaphthalene), metal phthalocyanine series high polymers, other conjugated high polymers (such as poly(p-xylene) and poly[α-(5,5′-bithiophenediyl)benzylidene]), and derivatives thereof.

Of these polymers, poly(p-phenylene), polypyrrole, polythiophene, polyaniline, poly(p-phenylenevinylene), and poly(2,5-thienylenevinylene) are preferred, polythiophene, polyaniline, polypyrrole, and derivatives of these polymers are more preferred, and at least either polythiophene or a derivative thereof is still more preferred.

Specific examples of these electron-conducting compounds are illustrated below, but the invention should not be construed as being limited by these examples. In addition to these compounds, the compounds described in WO 98/01909 can also be illustrated.

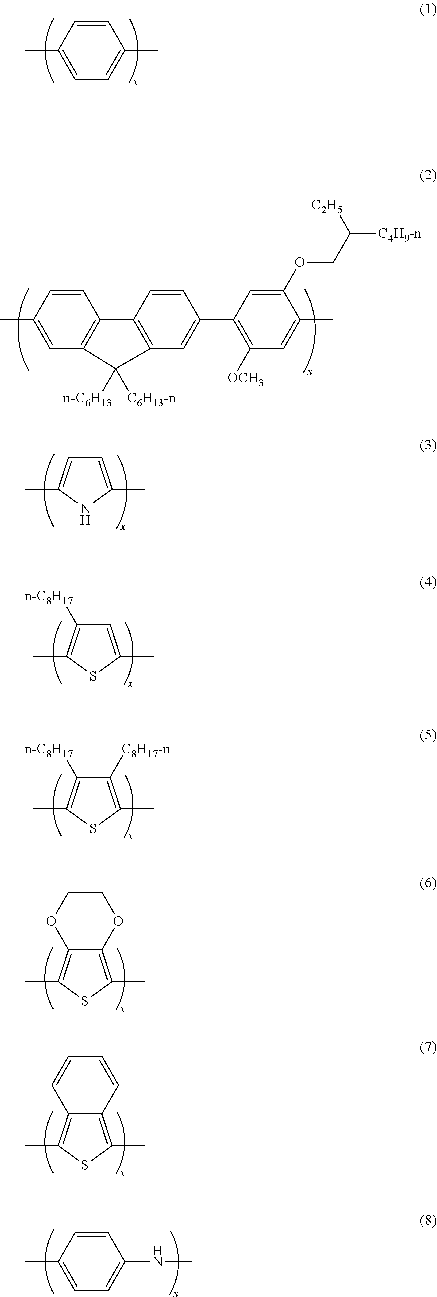

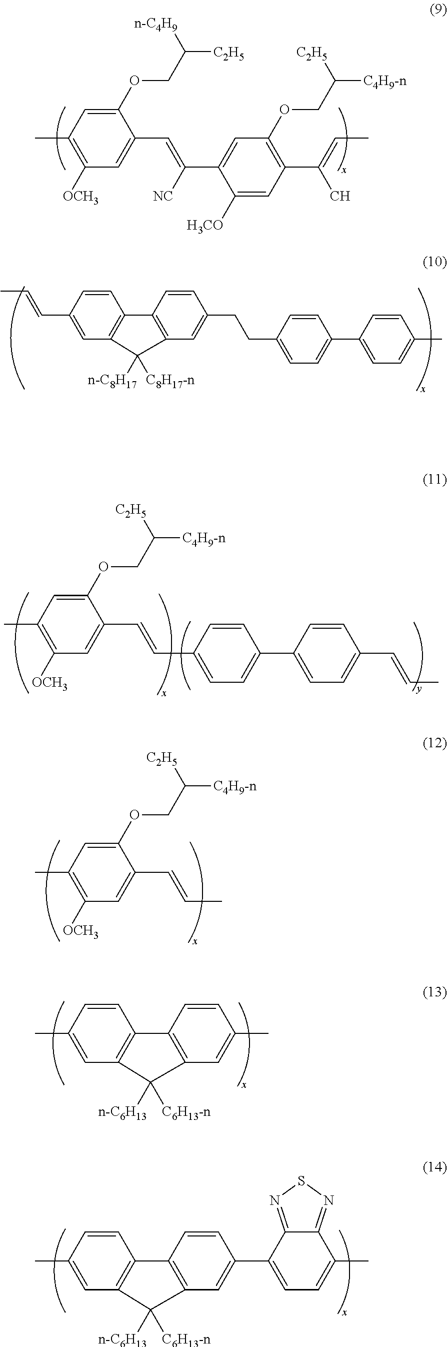

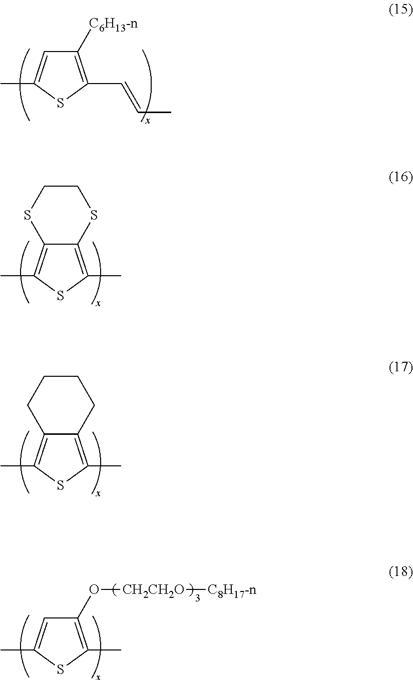

The weight-average molecular weight of electron-conducting compounds to be used in the invention is preferably from 1,000 to 1,000,000, more preferably from 10,000 to 500,000, still more preferably from 10,000 to 100,000. The term weight-average molecular weight used herein refers to the weight-average molecular weight measured by gel permeation chromatography and calculated in terms of polystyrene.

From the viewpoint of ensuring coating suitability and affinity for other ingredients, it is appropriate that the electron-conducting compounds to be used in the invention are soluble in organic solvents. The term “soluble” used herein refers to the state in which single molecules are dissolved in a solvent separately or in a condition that a plurality of single molecules are associated, or the state in which particles of 300 nm or below in size are dispersed in a solvent.

Electron-conducting compounds generally have hydrophilic properties since they are soluble in solvents containing water as their main ingredient. In order to dissolve such electron-conducting compounds in organic solvents, compounds capable of enhancing affinity for organic solvents (e.g. solubilization aids) or dispersants suitable for use in organic solvents are added to or polyanion dopants having undergone hydrophobicity-imparting treatment are used in compositions containing electron-conducting compounds. By the use of such a method, electron-conducting compounds become soluble in the organic solvents specified in the invention, but they still retain hydrophilic properties as a whole, and can be distributed as conductive compounds by applying thereto the method of the invention.

When the conductive compound used is a compound having a quaternary ammonium base, the nitrogen or sulfur atom content in the surface-side of the antistatic layer is preferably from 0.5 to 5 mol %, as determined by elemental analysis using electron spectroscopy for chemical analysis (referred to as ESCA). In such a content range, satisfactory antistatic properties are easy to attain. The nitrogen or sulfur atom content is more preferably from 0.5 to 3.5 mol %, still more preferably from 0.5 to 2.5 mol %.

The composition for forming the hard coat layer of the invention may or may not contain the conductive compound (e) but, in the case of containing the conductive compound (e), the content thereof is preferably from 5 to 20% by weight, more preferably from 10 to 15% by weight, based on the weight of all of the solid components in the composition for forming the hard coat layer.

[Silica Fine Particles]

The size of silica fine particles (primary particle size) is from 15 nm to less than 100 nm, more preferably from 20 nm to 80 nm, most preferably from 25 nm to 60 nm. The average particle size of fine particles can be determined from photography of electron microscope. When the particle size of the inorganic fine particles is too small, there results less effect of enhancing surface-distributing properties of the leveling agent whereas, when too large, fine unevenness is formed on the surface of the hard coat layer, which leads to deterioration of appearance such as jet black properties and deterioration of integral reflectance. The silica fine particles may be crystalline or amorphous, and may be mono-disperse particles or, as long as requirement for particle size is satisfied, may be aggregated particles. As to shape of the particles, a spherical shape is most preferred, but particles of other shapes than sphere, such as shapeless particles may be employed as well. Also, two or more kinds of silica fine particles different from each other in average particle size may be used in combination thereof.

The silica fine particles which can be used in the invention may be subjected to surface treatment for improving dispersibility in a coating solution and improving film thickness. Specific examples and preferred examples of the surface-treating method are the same as described in paragraphs [0119] to [0147] of JP-A-2007-298974.

As specific examples of the silica fine particles, MiBK-ST and MiBK-SD (both being silica sols having an average particle size of 15 nm and manufactured by Nissan Chemical Industries, Ltd.), MEK-ST-L (silica sol; average particle size: 50 nm; manufactured by Nissan Chemical Industries, Ltd.) can preferably be used.

In addition to these ingredients, additives may further be contained in the hard coat layer of the invention. As such additives to be further contained, there can be illustrated a UV ray absorbent, phosphorous esters, hydroxamic acid, hydroxylamine, imidazole, hydroquinone, and phthalic acid, which are used for the purpose of suppressing decomposition of the polymer. Also, there are illustrated inorganic fine particles, polymer fine particles, and silane coupling agents to be used for the purpose of enhancing film strength; fluorine-containing compounds (particularly, fluorine-containing surfactants) to be used for the purpose of reducing refractive index to thereby enhance transparency, and matt particles to be used for imparting internal scattering.

(Method for Coating Hard Coat Layer)

The hard coat layer for the optical film of the invention can be formed according to the following methods.

Initially, a composition for forming the hard coat layer is prepared. Then, the composition is coated on a transparent support by a dip coating method, an air-knife coating method, a curtain coating method, a roller coating method, a wire-bar coating method, a gravure coating method, a die coating method, or the like, and is heated to dry. Of these methods, a micro gravure coating method, a wire-bar coating method, and a die coating method (see, U.S. Pat. No. 2,681,294 and JP-A-2006-122889), with a die coating method being particularly preferred.

After being coated on the transparent support, the hard coat layer is conveyed to a heated zone on a web for removing the solvent. The temperature in the drying zone is preferably from 25° C. to 140° C. It is preferred that the temperature in the first half of the drying zone is at a comparatively low level and that in the second half of the drying zone is at a comparatively high level. However, the temperature is preferably lower than a temperature at which other ingredients than the solvent contained in the coating composition for each layer starts to vaporize. For example, some of commercially available photo radical generators to be used in combination with a UV ray-curable resin vaporize in an amount of about 10% thereof within several minutes in a 120° C. hot air condition, and some of mono- or bi-functional acrylate monomers progressively vaporizes in a 100° C. hot water condition. In such cases, the temperature is preferably less than a temperature at which other ingredients than the solvent contained in the coating composition for forming the hard coat layer starts to vaporize, as is described hereinbefore.

Also, in order to prevent to cause drying unevenness, the drying air to be applied after coating the coating composition for the hard coat layer on a substrate film is preferably from 0.1 to 2 m/sec in air velocity on the coated film surface during the period wherein the content of solid components in the coating composition is between 1 to 50%.

Also, after coating the coating composition of the hard coat layer on the substrate film, the difference between the temperature of a convey roll in contact with the opposite side of the substrate film to the coated side thereof and the temperature of the substrate film is preferably within 0° C. to 20° C. in view of preventing drying unevenness due to non-uniform heat transmission.

After the drying zone for removing the solvent, the film is passed, on the web, through a zone where the hard coat layer is cured by irradiation with ionizing radiation to thereby cure the coated film. For example, with a UV ray-curable coated film, it is preferred to cure the coated film by irradiating with UV rays in an irradiation amount of from 10 mJ/cm² to 1,000 mJ/cm². In this occasion, the irradiation amount localization in the width direction of the web is preferably such that the irradiation amount is maximum at the center and that it distributes between 50 to 100% including both edge portions, with 80 to 100% being more preferred. Further, in the case where it is necessary to reduce oxygen density by purge with a nitrogen gas in order to accelerate surface curing, the oxygen concentration is preferably from 0.01% to 5%, and the localization thereof in the width direction is preferably 2% or less. In the case of irradiating with UV rays, UV rays emitted from light sources such as a super-high-pressure mercury lamp, a high-pressure mercury lamp, a low-pressure mercury lamp, a carbon arc, a xenon arc, a metal halide lamp, etc. can be utilized. Also, in order to accelerate the curing reaction, it is also possible to increase the temperature upon curing. Such temperature is preferably from 25 to 100° C., more preferably from 30 to 80° C., most preferably from 40 to 70° C.

The hard coat layer of the invention can be coated, dried, and cured as described above. Also, as will be described hereinafter, other functional layers can be provided as needed. In the case of providing other functional layers in addition to the hard coat layer, plural layers may be coated simultaneously or successively. Methods for producing the layers can be conducted according to the method for producing the hard coat layer.

[Layer Structure of Hard Coat Layer and Functional Layer]

The optical film of the invention has the hard coat layer on a transparent support and may optionally have a single layer or plural layers having necessary functions according to end uses. For example, an antireflection layer (a layer having a controlled refractive index, such as a low refractive index layer, a medium refractive index layer, and a high refractive index layer), an antiglare layer, an antistatic layer, a UV ray absorbing layer, and an antifouling layer can be provided.

More specific layer structures of the optical film of the invention are shown below: optically anisotropic layer/transparent support/hard coat layer;

optically anisotropic layer/transparent support/hard coat layer/low refractive index layer; optically anisotropic layer/transparent support/hard coat layer/high refractive index layer/low refractive index layer; and
optically anisotropic layer/transparent support/hard coat layer/medium refractive index layer/high refractive index layer/low refractive index layer.

As materials which can be used for these functional layers and detailed structural constitutions, those which are described in paragraphs 0018 to 0167, 0170 to 0183, and 0187 to 0243 of JP-A-2010-152311 can be used.

Transparent Support

### [Material for Transparent Support]

The material for the transparent support of the invention is preferably a polymer having excellent optical transparency, mechanical strength, thermal stability, water-impermeability, and isotropy. The term “transparent” as used herein means that percent transmission is 60% or more, preferably 80% or more, particularly preferably 90% or more. For example, polycarbonate polymer, polyester polymer such as polyethylene terephthalate and polyethylene naphthalate, acrylic polymer such as polymethyl methacrylate, and styrenic polymer such as polystyrene and acrylonitrile/styrene copolymer (AS resin) are illustrated. Other examples of the polymer for use herein are polyolefin such as polyethylene and polypropylene; polyolefinic polymer such as ethylene/propylene copolymer; vinyl chloride polymer; amide polymer such as nylon and aromatic polyamide; imide polymer; sulfone polymer; polyether sulfone polymer; polyether-ether ketone polymer; polyphenylene sulfide polymer; vinylidene chloride polymer; vinyl alcohol polymer; vinylbutyral polymer; allylate polymer; polyoxymethylene polymer; epoxy polymer; and mixture of any of the above-mentioned polymers. The high-molecular film of the invention may be formed as a cured layer of a UV-curable or thermosetting resin such as acrylic, urethane, acrylurethane, epoxy or silicone resin.

As the material for forming the transparent support of the invention, thermoplastic norbornene resin can preferably be used. The thermoplastic norbornene resin includes Zeonex and Zeonoa (manufactured by ZEON CORPORATION; and Arton (manufactured by JSR Corporation).

As the material for forming the transparent support of the invention, cellulose polymer (hereinafter referred to as cellulose acylate) such as typically triacetyl cellulose that has heretofore been used for transparent protective film for polarizing plates. As an example of the transparent support of the invention, cellulose acylate is mainly described in detail hereinafter, but it is apparent that the technical matters are similarly applicable to other high-molecular films.

### [Degree of Substitution in Cellulose Acylate]

Next, cellulose acylate to be produced from the above-mentioned cellulose material will be described. The cellulose acylate of the present invention is produced by acylating the hydroxyl group in cellulose, in which the substituent acyl group may have from 2 carbon atoms (acetyl group) to 22 carbon atoms. In the cellulose acylate of the invention, the degree of substitution of the hydroxyl group in cellulose is not specifically restricted. The degree of substitution may be calculated by measuring the bonding degree of acetic acid and/or fatty acid having from 3 to 22 carbon atoms substituted for the hydroxyl group in cellulose. It may be measured according to the method of ASTM D-817-91.

As described hereinabove, the degree of substitution of the hydroxyl group in cellulose to give cellulose acylate of the invention is not particularly restricted. Preferably, however, the degree of acyl substitution of the hydroxyl group in cellulose is from 2.50 to 3.00, more preferably from 2.75 to 3.00, still more preferably from 2.85 to 3.00.

Of acetic acid and/or fatty acid having from 3 to 22 carbon atoms to be introduced in the place of a hydrogen atom of the hydroxyl group in cellulose, the acyl group having from 2 to 22 carbon atoms may be selected from aliphatic groups or aromatic groups, though not particularly restricted. One or more different types of such acids may be used for the substitution either singly or as a combination thereof. The cellulose esters prepared by acylating with these includes, for example, alkylcarbonyl esters, alkenylcarbonyl esters, aromatic carbonyl esters and aromatic alkylcarbonyl esters of cellulose, which may be further substituted. Preferred examples of the acyl group are acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl groups. Of those, more preferred are acetyl, propionyl, butanoyl, dodecanoyl, octadecanoyl, t-butanoyl, oleoyl, benzoyl, naphthylcarbonyl, and cinnamoyl; and still more preferred are acetyl, propionyl, and butanoyl.

[Degree of Polymerization of Cellulose Acylate]

The degree of polymerization of the cellulose acylate preferably used in the invention is from 180 to 700 in terms of the viscosity-average degree of polymerization thereof. With cellulose acetate, the viscosity-average degree of polymerization is more preferably from 180 to 550, still more preferably from 180 to 400, particularly preferably from 180 to 350.

[Additive to Cellulose Acylate]

To the cellulose acylate of the invention may be added various additives (e.g., optical anisotropy-adjusting agent, wavelength dispersion-controlling agent, fine particles, plasticizer, UV-ray inhibitor, deterioration-preventing agent, and peeling agent). These additives will be described hereinafter. Also, the additives may be added to the dope anytime while the dope is prepared (in the step of preparing a solution of cellulose acylate). It is also possible to add the additives in a final step of preparing the dope. As specific examples of compounds capable of reducing optical anisotropy of the cellulose acylate film, there are illustrated those compounds which are described in, for example, paragraphs [0035] to [0058] of JP-A-2006-199855. However, the invention is not limited only to these compounds.

[Additives to Transparent Support]

Since the optical film of the invention is to be used in many cases on the viewing side of a display, it is preferred to incorporate a UV absorbent (UV ray absorbent) in the transparent support. Specific examples of the UV absorbent for the cellulose acylate film are described in, for example, paragraphs [0059] to [0135] of JP-A-2006-199855.

[Matting Agent Fine Particles]

Fine particles are preferably added as a matting agent, to the cellulose acetate film of the invention. Examples of the fine particles that can be used in the invention may include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate. The fine particles are preferably those which contain silicon from the viewpoint of obtaining low turbidity, with silicon dioxide being particularly preferred. Fine particles of silicon dioxide are preferably those which have a primary average particle size of 20 nm or less and an apparent specific gravity of 70 g/L or more. Particles having a primary average particle size as small as 5 to 16 nm are able to reduce the haze of the film, thus being more preferred. The apparent specific gravity is preferably 90 to 200 g/L or more, more preferably 100 to 200 g/L or more. A larger apparent specific gravity makes it more possible to prepare a highly concentrated dispersion, which serves to provide better haze and coagulation, thus being preferred.

These fine particles usually form secondary particles having an average particle size of 0.1 to 3.0 μm, and these fine particles exist in the form of an aggregate of primary particles in the film to form projections of 0.1 to 3.0 μm on the surface of the film. The secondary average particle size is preferably 0.2 μm or more and 1.5 μm or less, more preferably 0.4 μm or more and 1.2 μm or less, most preferably 0.6 μm or more and 1.1 μm or less. The primary particle size and the secondary particle size are determined in the following manner: Particles in the film are observed by a scanning type electron microscope to measure the diameter of a circumscribed circle of a particle as a particle size. Also, 200 particles each in a different place are observed to calculate an average of the diameters of these particles to determine an average particle size. Also, the state of unevenness on the film surface can be measured by the technique of, for example, AFM.

The surface of the transparent support, having the projections, is preperably a surface on which the optical anisotropic layer is not stacked.

As the fine particles of silicon dioxide, commercially available products under such trade names as Aerosil R972, R972V, R974, R812, 200, 200V, 300, R202, OX50, TT600 (these being manufactured by Nippon Aerosil Co., Ltd.) may be used. As the fine particles of zirconium oxide, commercially available products under such trade names as Aerosil R976 and R811 (both being manufactured by Nippon Aerosil Co., Ltd.) may be used.

Among these, Aerosil 200V and Aerosil R972V are particularly preferred, since they are fine particles of silicon dioxide having an average primary particle size of 20 nm or less and an apparent specific gravity of 70 g/L or more, and having a large effect of dropping friction coefficient while maintaining the low turbidity of a resulting optical film.

[Plasticizer, Deterioration-Preventing Agent, and Peeling Agent]

In addition to the compounds capable of optically reducing anisotropy and UV absorbents, various additives (e.g., plasticizers, deterioration-preventing agents, peeling agents, infrared ray absorbents, etc.) may be added, as described hereinbefore, to the cellulose acylate film of the invention. They may be a solid product or an oily product. Detailed descriptions on these materials are given on pages 16 to 22 of Kokai Giho of Japan Institute of Invention and Innovation (Kogi No. 2001-1745, published on Mar. 15, 2001).

[Knurling]

The transparent support of the invention preferably has knurling portions at the film edges of the transparent support in order to suppress generation of black band or deformation of the film upon handling it in a roll form even when the transparent support has a large width and a small thickness. The knurling portions of the invention means portions which have a larger height and which are formed by imparting unevenness at the edges in the width direction of the transparent continuous support, and are preferably provided on both edges thereof. As a method for imparting unevenness to form the knurling portion, the knurling portion can be formed by pressing a heated emboss roll to the film. Fine unevenness is formed on the emboss roll, and unevenness of the film can be formed by pressing this against the film to impart a larger height to the edges. The height of knurling in the invention means the height from the film surface to top of the projection formed by embossing. The knurling portions may be provided on both surfaces of the film, or 3 or more knurling portions may be formed on one surface. The height of the knurling portion is preferably a height larger than the entire film thickness of the optical functional layers including the optically anisotropic layer and the hard coat layer, by 1 μm or more, and the width of one knurling portion is preferably in the range of from 5 mm to 30 mm. In the case of providing the knurling portions on both sides of the film, it suffices that sum of the height of each knurling portion is larger by at least 1 μm or more. By adjusting the height larger by 1 μm or more, the effect of suppressing generation of black band and deformation of the film is obtained. The height of the knurling portion be preferably larger than the thickness of the entire optically functional film by 2 μm to 10 μm. By controlling the height in this range, generation of black band and deformation of the film can be prevented, and troubles of deformation of support due to winding slippage or bulge of the knurling portion do not occur.

In the invention, in the case where the thickness of the entire functional layers on both surfaces is as large as 3 μm or more and the functional layers have such a high surface smoothness that, when wound in a roll form, the layers are liable to closely adhere to each other, it is also possible to provide, prior to providing the optically anisotropic layer, knurling portions on the transparent support at the same or different positions on both surfaces thereof, to further provide, after providing the optically anisotropic layer, other knurling portions on the surface or back side of the support, or to conduct additional knurling at the already formed knurling portion after providing the optically anisotropic layer.

As to imparting knurling portion, methods described in JP-A-2005-99245 and JP-A-2005-219272 can be employed.

The width of the transparent continuous support is preferably from 1400 mm to 4000 mm, particularly preferably from 1400 to 3000 mm, because such support provides high productivity and high available efficiency in the case of applying the optical film to an image display device. In the case of using such wide transparent continuous support, the above-described first knurling portion and the second knurling portion are preferably provided not only at the edges of the transparent support but in the inside thereof. That is, it is preferable to provide plural rows of knurling portions on the transparent support. For example, when a knurling portion is provided at the center of the transparent support, blocking which is liable to occur at around the center of the wide transparent support can be prevented effectively. Also, the length of the transparent continuous support is preferably from 100 to 6000 m, more preferably from 500 to 4000 m.

[Optically Anisotropic Layer]

In the invention, materials and production conditions can properly be selected according to various uses, and a λ/4 film using the polymerizable liquid crystalline compound is one preferred embodiment.

Initially, methods for measuring optical characteristics are described below. In this specification, Re(λ) and Rth(λ) indicate the in-plane retardation and the thickness-direction retardation of a film at a wavelength λ, respectively. Re(λ) is determined, using KOBRA 21ADH or WR (manufactured by Oji Scientific Instruments), with light having a wavelength of λnm given to a film in the normal direction thereof. Upon selecting the measuring wavelength λ, a wavelength-selecting filter is manually exchanged or the measuring value is changed by programming before measurement. In the case where the film to be analyzed is a monoaxial or biaxial refractive index ellipsoid, its Rth(λ) is calculated as follows. Additionally, this measuring method is partly utilized in measuring the average tilt angle of discotic liquid crystal molecule in the optically anisotropic layer (to be described hereinafter) on the orientation film side and the average tilt angle on the opposite side.

Rth(λ) is calculated with KOBRA 21ADH or WR based on the retardation that is obtained by measuring the Re(λ) at a total of 6 points in directions inclined every 10° from the normal direction thereof to 50° from the normal line relative to the film surface around an in-plane slow axis (determined by KOBURA 21ADH or WR) as an inclination axis (rotation axis) (in the case where the film does not have a slow axis, any desired in-plane direction of the film may be taken as the rotation axis) for an incident light of a wavelength of λnm entering from each of the directions of inclination, an average refraction index, and inputted film thickness.

In the above, for the film having a tilt angle at which the retardation thereof is zero with the in-plane slow axis from the normal direction taken as the rotation axis, its retardation at a tilt angle larger than that tilt angle is converted into the corresponding negative value and then calculated by KOBRA 21ADH or WR. Additionally, with the slow axis taken as the tilt axis (rotation axis) (in the case where the film does not have a slow axis, any desired in-plane direction of the film may be taken as the rotation axis), a retardation is determined in any desired two tilt directions and, based on the found data and the mean refractive index and the inputted film thickness, Rth of the film may also be calculated according to the following formulae (A) and (III):

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Formula ( A )$$

In the above formula, Re(θ) represents a retardation in the direction tilted by an angle θ from the normal direction; nx in formula (A) represents the refractive index in the in-plane slow axis direction; ny represents the refractive index in the direction perpendicular to the in-plane nx; and nz represents the refractive index in the direction perpendicular to nx and ny.

Rth=((nx+ny)/2−nz)×d

In the case where the film to be analyzed cannot be expressed as a monoaxial or biaxial refractive index ellipsoid, or in the case where the film to be analyzed has no optical axis, then its Rth(λnm) may be calculated as follows:

Rth(λ) is calculated with KOBRA 21ADH or WR based on the retardation that is obtained by measuring the Re (λ) at a total of eleven points in directions inclined every 10° from −50° up to +50° from the normal line relative to the film surface around an in-plane slow axis (determined by KOBURA 21ADH or WR) as an inclination axis (rotation axis) for an incident light of a wavelength of λnm entering from each of the directions of inclination, an average refraction index and inputted thickness. Also, in the above measurement, as the average refractive index, catalogue values with various optical films described in Polymer Hand-book (JOHN WILEY & SONS<INC.) may be employed. With polymers having unknown average refractive index, the value may be obtained by measuring with an Abbe refractometer. Average refractive indices of major optical films are illustrated below: cellulose acylate (1.48); cycloolefin polymer (1.52); polycarbonate (1.59); polymethyl methacrylate (1.49); and polystyrene (1.59). By inputting the value of these average refraction indices and thickness, KOBRA 21ADH or WR calculates nx, ny, and nz. Further, Nz=(nx−nz)/(nx−ny) is calculated from the calculated nx, ny, and nz.

[Optically Anisotropic Layer Containing Liquid Crystalline Compound]

The kind of a liquid crystalline compound to be used for forming the optically anisotropic layer which the optical compensatory film has is not particularly limited. For example, an optically anisotropic layer, which can be obtained by forming a low molecular liquid crystalline compound in the nematic alignment in liquid crystal state, and forming an optically anisotropic layer which can be obtained by subjecting to fixation by optically crosslinking or thermally crosslinking, or forming a high molecular liquid crystalline compound in the nematic alignment in liquid crystal state, and then cooling to fixate the alignment, can be used. Further in the invention, even when a liquid crystalline compound is used in the optically anisotropic layer, the optically anisotropic layer is a layer fixed and formed by the polymerization or the like of the liquid crystalline compound, thus does not need to show crystallinity once the layer is formed. The polymerizable liquid crystalline compound may be a multifunctional polymerizable liquid crystalline compound, and may also be a monofunctional polymerizable liquid crystalline compound. In addition, the liquid crystalline compound may be a discotic liquid crystalline compound, and may also be a rod-shaped liquid crystalline compound.

In the optically anisotropic layer, the molecules of the liquid crystalline compound are preferably fixed in any one of the vertical alignment, the horizontal alignment, the hybrid alignment, and the inclined alignment. In order to prepare a retardation plate having symmetrical viewing angle dependence, it is preferred that disc plane of the discotic liquid crystalline compound is substantially vertical to the film plane (optically anisotropic layer plane) or that the long axis of the rod-shaped liquid crystalline compound is substantially horizontal to the film plane (optically anisotropic layer plane). That the discotic liquid crystalline compound is substantially vertical means that the average value of angles between the film plane (optically anisotropic layer plane) and the discotic plane of the discotic liquid crystalline compound is within the range of from 70° to 90°, with the average value being more preferably from 80° to 90°, still more preferably 85° to 90°. That the rod-shaped liquid crystalline compound is substantially horizontal means that the average value of angles between the film plane (optically anisotropic layer plane) and the director of the rod-shaped liquid crystalline compound is within the range of from 0° to 20°, with the average value being more preferably from 0° to 10°, still more preferably 0° to 5°.

In the case of preparing an optically compensatory film having non-symmetrical viewing angle dependence by orienting molecules of the liquid crystalline compound in a hybrid alignment, the average tilt angle of the director of the liquid crystalline compound is preferably from 5 to 85°, more preferably from 10 to 80°, still more preferably from 15 to 75.

The optical film contains the optically anisotropic layer containing the liquid crystalline compound. The optically anisotropic layer may be composed of a single layer or may be a layered body of two or more optically anisotropic layers.

The optically anisotropic layer can be formed by coating on a support a coating solution containing a liquid crystalline compound such as a rod-shaped liquid crystalline compound or a discotic liquid crystalline compound and, as needed, a polymerization initiator, an alignment controlling agent, and other additives to be described hereinafter. It is preferred to form the optically anisotropic layer by forming an orientation film on the support and coating the above-described coating solution on the surface of the orientation film.

[Discotic Liquid Crystalline Compound]

In the invention, it is preferred to form an optically anisotropic layer which the optical film has by using a discotic liquid crystalline compound. The discotic liquid crystalline compound is described in various publications (C. Destrade, et al., Mol. Crysr. Liq. Cryst., Vol. 71, p. 111 (1981); Chemical Society of Japan, Quarterly Journal of General Chemistry, No. 22, Chemistry of Liquid Crystal, Chap. 5, Chap. 10, Sec. 2 (1994); B. Kohne, et al. Angew. Chem. Soc. Chem. Comm., p. 1794 (1985); J. Zhang, et al., J. Am. Chem. Soc., Vol. 116, p. 2655 (1994)). Polymerization of a discotic liquid crystalline compound is described in JP-A-8-27284.

As specific examples of discotic liquid crystalline compounds which can be preferably used in the invention, there are illustrated compounds described in paragraphs [0038] to [0069] of JP-A-2009-97002. Also, as triphenylene compounds which are discotic liquid crystalline compounds having a small wavelength dispersion, there are illustrated compounds described in paragraphs [0062] to [0067] of JP-A-2007-108732.

[Rod-Shaped Liquid Crystalline Compound]

In the invention, a rod-shaped liquid crystalline compound may be used. As the rod-shaped liquid crystalline compound, azomethines, azoxys, cyano biphenyls, cyano phenyl esters, benzoic acid esters, cyclohexanecarboxylic acid phenyl esters, cyano phenylcyclohexanes, cyano-substituted phenylpyrimidines, alkoxy-substituted phenylpyrimidines, phenyldioxanes, tolanes, and alkenyl cyclohexylbenzonitriles are preferably used. Not only these low-molecular weight liquid crystalline compounds, but also high-molecular weight liquid crystalline compounds can be used. It is more preferred to fix the alignment by polymerization of a rod-shaped liquid crystalline compound. A liquid crystalline compound having a partial structure which may undergo polymerization or crosslinking reaction with active light or electron ray, heat or the like can be preferably used. The number of such partial structures is preferably 1 to 6, more preferably 1 to 3. As the polymerizable rod-shaped liquid crystalline compound, compounds described in Makromol. Chem., Vol. 190, p. 2255 (1989), Advanced Materials, Vol. 5, p. 107 (1993), U.S. Pat. Nos. 4,683,327, 5,622,648 and 5,770,107, WO95/22586, WO95/24455, WO97/00600, WO98/23580, WO98/52905, JP-A-1-272551, J-A-6-16616, JP-A-7-110469, JP-A-11-80081, and JP-A-2001-328973 can be used.

[Vertical Alignment Promoting Agent]

In order to uniformly align a liquid crystalline compound vertically upon forming the optically anisotropic layer, it is preferred to use an alignment controlling agent capable of vertically controlling alignment of the liquid crystalline compound in an alignment layer interface side and in an air interface side. For this purpose, it is preferred to form an optically anisotropic layer by using, for the alignment film, a composition which contains a compound that exerts the action of vertically aligning the liquid crystalline compound through an exclusion volume effect, an electrostatic effect, or a surface energy effect together with the liquid crystalline compound. Also, with respect to regulating the alignment on the side of the air interface side, it is preferred to form the optically anisotropic layer by using, upon alignment of the liquid crystalline compound, a composition which contains a compound that exerts the action of vertically aligning the liquid crystalline compound through an exclusion volume effect, an electrostatic effect, or a surface energy effect together with the liquid crystalline compound. As the compound (alignment layer interface side vertical alignment material) that promotes vertical alignment of the molecules of the liquid crystalline compound at the interface side of these alignment layers, a pyridinium derivative can be preferably used. As a compound (air interface side vertical alignment agent) that promotes vertical alignment of the molecules of the liquid crystalline compound at the air interface side of these alignment layers, a compound, which promotes localization of the above-mentioned compounds on the air interface side, containing at least one or more hydrophilic groups selected from a fluoro-aliphatic group, a carboxyl group (—COOH), a sulfo group (˜SO₃H), a phosphonoxy group {—OP(═O)(OH)₂}, and their salts can be preferably used. Further, by blending these compounds, in the case of, for example, preparing the crystalline compound as a coating solution, the coatability of the coating solution is improved, and thus generation of unevenness and repelling are suppressed. The vertical alignment agent will be described in detail below.

[Alignment Layer Interface Side Vertical Alignment Agent]

As the alignment layer interface side vertical aligning agent usable in the invention, a pyridinium derivative (pyridinium salt) can be suitably used. As specific examples of such compound, there are illustrated those compounds which are described in paragraphs [0058] to [0061] of JP-A-2006-113500.

The content of the pyridinium derivative in the composition for forming the optically anisotropic layer is preferably in the range of from 0.005 to 8% by weight, more preferably from 0.01 to 5% by weight, in the composition (a liquid crystalline composition excluding a solvent in the case of preparing the composition as a coating solution), though varying depending upon its use.

[Air Interface Vertically Aligning Agent]

As the air interface vertically aligning agent in the invention, the following fluorine-containing polymers (containing formula (II) as a partial structure) or the fluorine-containing compounds represented by the following general formula (III) is preferably used.

First, fluorine-containing polymer (containing formula (II) as a partial structure) will be described. As the air interface vertically aligning agent, the fluorine-containing polymer is preferably a copolymer containing a repeating unit derived from a fluoro-aliphatic group-containing monomer and a repeating unit represented by the following formula (II).

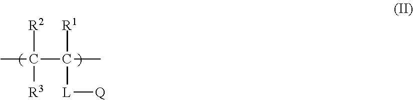

In the formula, each of R¹, R², and R³ independently represents a hydrogen atom or a substituent; L represents a divalent linking group selected from among the following linking groups or a divalent linking group formed by combining two or more of the following linking groups [linking groups: single bond, —O—, —CO—, —NR⁴— (wherein R⁴ represents a hydrogen atom, an alkyl group, an aryl group, or an aralkyl group), —S—, —SO₂—, —P(═O)(OR⁵)— (wherein R⁵ represents an alkyl group, an aryl group, or an aralkyl group), an alkylene group, and an arylene group]; and Q represents a carboxyl group (—COOH) or its salt, a sulfo group (—SO₃H) or its salt, or a phosphonoxy {—OP(═O)(OH)₂} or its salt.

The fluorine-containing polymer which can be used in the invention is characterized in that it contains a fluoro-aliphatic group and one or more hydrophilic groups selected from the group consisting of a carboxyl group (—COOH), a sulfo group (—SO₃H), or a phosphonoxy {—OP(═O)(OH)₂}, and salts thereof. As to kinds of the polymers, related descriptions are given on pages 1 to 4 in “Revised Chemistry of Polymer Synthesis (Kaitei Porimar Gousei no Kagaku)” written by OHTSU TAKAYUKI and published by Kagaku-Dojin Publishing Company, Inc in 1968. Examples thereof include polyolefins, polyesters, polyamides, polyimides, polyurethanes, polycarbonates, polysulfones, polyethers, polyacetals, polyketones, polyphenylene oxides, polyphenylene sulfides, polyarylates, PTFEs, polyvinylidene fluorides, and cellulose derivatives. The fluorine-containing polymer is preferably a polyolefin.

The fluorine-containing polymer is a polymer which has a fluoro-aliphatic group in side chain. The fluoro-aliphatic group contains preferably from 1 to 12 carbon atoms, more preferably from 6 to 10 carbon atoms. The aliphatic group may have a chain or cyclic structure, and the chain structure may be straight or branched. Among those, straight C₆₋₁₀ fluoro-aliphatic groups are preferred. The fluorine-substitution degree of the fluoro-aliphatic group is preferably decided, however not to be limited to, such that not less than 50%, more preferably not less than 60%, of the hydrogen atoms in the aliphatic group are replaced with fluorine atoms. The fluoro-aliphatic group in side chain is bound to the main chain through a linking group such as an ester bond, amido bond, imido bond, urethane bond, urea bond, ether bond, thioether bond, or aromatic ring.

As specific examples of the fluoro-aliphatic group-containing copolymer to be preferably used in the invention as the fluorine-containing polymer, there are illustrated those compounds which are described in paragraphs [0110] to [0114] in JP-A-2006-113500. However, the invention is not restricted at all by those specific examples.

The weight-average molecular weight of the fluorine-containing polymer to be used in the invention is preferably 1,000,000 or less, more preferably 500,000 or less, still more preferably 100,000 or less. The weight-average molecular weight can be measured as a value in terms of polystyrene (PS) using gel permeation chromatography (GPC).

Additionally, it is also preferred for the fluorine-containing polymer of the invention to have a polymerizable group as a substituent in order to fix the alignment state of the discotic crystalline compound.

A preferred range of the content of the fluorine-containing polymer in the composition varies depending upon its use but, in the case of using for forming an optically anisotropic layer, the content (composition excluding a solvent in the case of preparing the composition as a coating solution) is preferably from 0.005 to 8% by weight, more preferably from 0.01 to 5% by weight, still more preferably from 0.05 to 3% by weight. In case when the addition amount of the fluorine-containing polymer is less than 0.005% by weight, there results insufficient effects whereas, in case when the content exceeds 8% by weight, drying of the coated film becomes insufficient, and detrimental influences are exerted on performance as an optical film (for example, uniformity of retardation).

Fluorine-containing compounds represented by the following (III).

(R⁰)ₘ-L⁰-(W)ₙ (III):

In formula (III), R⁰ represents an alkyl group, an alkyl group having a CF₃ group at the end, or an alkyl group having a CF₂H group at the end, m represents an integer of 1 or more. Each R⁰ may be the same as or different from every other R⁰, with at least one representing an alkyl group having a CF₃ group or a CF₂H group at the end. L⁰ represents an (m+n)-valent linking group, W represents a carboxyl group (—COOH) or its salt, a sulfo group (—SO₃H) or its salt, or a phosphonoxy {—OP(═O)(OH)₂} or its salt, and n represents an integer of 1 or more.

As specific examples of the fluorine-containing compound usable in the invention and represented by formula (III), there are illustrated those compounds which are described in paragraphs [0136] to [0140] in JP-A-2006-113500. However, the invention is not restricted at all by those specific examples.

Additionally, it is also preferred for the fluorine-containing compound of the invention to have a polymerizable group as a substituent in order to fix the alignment state of the discotic crystalline compound.

A preferred range of the content of the fluorine-containing compound in the composition varies depending upon its use but, in the case of using for forming an optically anisotropic layer, the content (composition excluding a solvent in the case of preparing the composition as a coating solution) is preferably from 0.005 to 8% by weight, more preferably from 0.01 to 5% by weight, still more preferably from 0.05 to 3% by weight.

[Polymerization Initiator]

The aligned (preferably vertically aligned) liquid crystalline compound is fixed with maintaining the alignment state. Fixation is preferably conducted by polymerization reaction of a polymerizable group (P) introduced into the liquid crystalline compound. The polymerization reaction includes thermal polymerization reaction using a thermal polymerization initiator and a photo polymerization reaction using a photo polymerization initiator, with photo polymerization reaction being preferred. Examples of the photo polymerization initiator include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketone (described in U.S. Pat. No. 3,549,367), acridine and phenazine compounds (described in JP-A-60-105667 and U.S. Pat. No. 4,239,850), and oxadiazole compounds (described in U.S. Pat. No. 4,212,970).

The amount of the photo polymerization initiator to be used is preferably from 0.01 to 20% by weight, more preferably from 0.5 to 5% by weight, based on the weight of the solid components of the coating solution. Light irradiation for polymerizing the liquid crystalline compound is preferably conducted by using UV rays. The irradiation energy is preferably from 20 mJ/cm² to 50 J/cm², more preferably from 100 to 800 mJ/cm². In order to accelerate photo polymerization reaction, light irradiation may be conducted under heating condition or at a low oxygen concentration of 0.1% or less. The thickness of the optically anisotropic layer containing the liquid crystalline compound is preferably from 0.1 to 10 μm, more preferably from 0.5 to 5 μm, most preferably from 1 to 5 μm.

[Other Additives to Optically Anisotropic Layer]

A plasticizer, a surfactant, a polymerizable monomer, or the like may be used together with above-mentioned liquid crystalline compound to improve uniformity of the coated film, film strength, and aligning properties of the liquid crystalline compound. These materials preferably have compatibility with the liquid crystalline compound so as not to inhibit alignment.

As the polymerizable monomer, there are illustrated radical-polymerizable or cation-polymerizable compounds. Polyfunctional radical-polymerizablel monomers are preferred, and those which are copolymerizable with the above-mentioned polymerizable group-containing liquid crystalline compound. For example, there are illustrated those described in paragraphs [0018] to [0020] in JP-A-2002-296423. The addition amount of the above-described compound is generally in the range of from 1 to 50% by weight, preferably in the range of from 5 to 30% by weight, based on the weight of the liquid crystalline compound.

As the surfactant, there are illustrated conventionally known compounds, with fluorine-containing compounds being preferred. Specifically, there are illustrated, for example, compounds described in paragraphs [0069] to [0126] in Japanese Patent Application No. 2003-295212.

The polymer to be used together with the liquid crystalline compound preferably can thicken the coating solution. Examples of the polymer include cellulose esters. As preferred examples of such cellulose esters, there are illustrated compounds described in paragraph

in JP-A-2000-155216. The addition amount of the above-described polymer is preferably in the range of from 0.1 to 10% by weight, more preferably in the range of from 0.1 to 8% by weight, based on the weight of the liquid crystalline compound so as not to inhibit alignment of the liquid crystalline compound.

The discotic nematic liquid crystal phase-solid phase transition temperature of the liquid crystalline compound is preferably from 70 to 300° C., more preferably from 70 to 170° C.

[Coating Solvent]

As solvents to be used for preparing the coating solution, organic solvents are preferably used. Examples of the organic solvent include amides (e.g., N,N-dimethylformamide), sulfoxides (e.g., dimethylsulfoxide), heterocyclic compounds (e.g., pyridine), hydrocarbons (e.g., benzene and hexane), alkyl halides (e.g., chloroform and dichloromethane), esters (e.g., methyl acetate, ethyl acetate, and butyl acetate), ketones (e.g., acetone and methyl ethyl ketone), and ethers (e.g., tetrahydrofuran and 1,2-dimethoxyethane). Of these, alkyl halides and ketones are preferred. Two or more organic solvents may be used in combination thereof.

[Coating Method]

Coating of the coating solution can be conducted according to known methods (a wire-bar coating method, an extrusion coating method, a direct gravure coating method, a reverse gravure coating method, and a die coating method).

[Alignment Film]

In the invention, it is preferred to coat the aforesaid composition on the surface of an alignment film to thereby align molecules of the liquid crystalline compound. Since the alignment film has the function of regulating alignment direction of the liquid crystalline compound, it is preferred to utilize the film to realize a preferred embodiment of the invention. However, after fixing the alignment state of the liquid crystalline compound, the alignment film is not necessary as a constituent of the invention since the alignment film has already served as an alignment film. That is, it is possible to transfer only the optically anisotropic layer, wherein the alignment state has been fixed, on the alignment film to a different transparent support to prepare an optical substrate for an optical film of the invention.

An alignment film can be prepared by means of the rubbing treatment of an organic compound (preferably a polymer), oblique evaporation of an inorganic compound, formation of a layer having microgrooves, or accumulation of organic compounds (e.g., ω-tricosanic acid, dioctadecylmethylammonium chloride, and methyl stearate) by Langmuir-Blodgett method. Further, an alignment film that exhibits an alignment function by a given electric field, a given magnetic field, or light irradiation, is also known.

The alignment film is preferably formed by rubbing treatment of a polymer.

Examples of the polymer include methacrylate series copolymers described in paragraph [0022] of JP-A-8-338913, styrene series copolymers, polyolefins, polyvinyl alcohol and modified polyvinyl alcohols, poly(N-methylolacrylamide), polyesters, polyimides, vinyl acetate copolymers, carboxymethyl cellulose, and polycarbonates. It is possible to use a silane coupling agent as a polymer. Water-soluble polymers (e.g., poly(N-methylolacrylamide), carboxymethyl cellulose, gelatin, polyvinyl alcohol, and modified polyvinyl alcohol) are preferred, gelatin, polyvinyl alcohol, and modified polyvinyl alcohols are more preferred, and polyvinyl alcohol and modified polyvinyl alcohols are most preferred.

The saponification degree of the polyvinyl alcohol is preferably from 70 to 100%, more preferably from 80 to 100%. The polymerization degree of polyvinyl alcohol is preferably from 100 to 5000.

In the alignment film, it is preferred to bind a side chain having a cross-linkable functional group (e.g., double bond) to the main chain or to introduce into the side chain a cross-linkable functional group having the function of aligning the liquid crystalline molecules. As the polymer to be used in the alignment film, either of polymers which itself can undergo cross-linking and a polymers which can be cross-linked with a cross-linking agent can be used, and a combination of plural of them can be used.

It is possible to copolymerize a polymer in an alignment film and a multi-functional monomer in an optically anisotropic layer, when the polymer in the alignment film has a main chain bonding to side chains containing a cross-linkable functional group or when the polymer in the alignment film has side chain being capable of aligning liquid-crystalline molecules and containing a cross-linkable functional group. In such case, not only between the multi-functional monomer and the multi-functional monomer but also between the polymer in the alignment film and the polymer in the alignment film and between the multi-functional monomer and the polymer in the alignment layer, strong covalent bonds are formed. Thus, in such case, the strength of the optical compensatory film can be remarkably improved by introducing a cross-linking functional group into the polymer in the alignment film.

The polymerizable functional group of the polymer in the alignment film preferably has a polymerizable group as with the multifunctional monomers. Specific examples include those described in paragraphs [0080] to [0100] in JP-A-2000-155216.

The polymer in the alignment film may be cross-linked by a cross-linking agent apart from the cross-linkable functional group. Examples of the cross-linking agent include aldehydes, N-methylol compounds, dioxane derivatives, compounds to act when their carboxyl groups are activated, active vinyl compounds, active halogen compounds, isoxazoles, and dialdehyde starches. Two or more of the cross-linking agents may be used in combination thereof. Specific examples of the cross-linking agent include the compounds described in paragraphs [0023] to [0024] in JP-A-2002-62426. Aldehydes having a high reactivity are preferred, with glutaraldehydes being particularly preferred.

The addition amount of the cross-linking agent is preferably from 0.1 to 20% by weight, more preferably from 0.5 to 15% by weight, based on the weight of the polymer. The residual amount of the unreacted cross-linking agent in the alignment film is preferably not greater than 1.0% by weight, more preferably not greater than 0.5% by weight. When the residual amount falls within the range, the alignment film has a sufficient durability, and even when the alignment film is used in a liquid-crystal display device for a long time, or is left under a high temperature and humidity atmosphere for a long time, no reticulation occurs in the alignment film.

The alignment film may be fundamentally formed by applying a solution containing the above-described polymer which is an alignment film-forming material, the cross-linking agent, and the additives to the surface of a transparent support, drying under heating (to cross-link), and performing a rubbing treatment. The cross-linking reaction may be carried out any time after applying the coating solution to the surface as described above. When a water-soluble polymer such as polyvinyl alcohol is used for preparation of an alignment film, the coating solution is preferably prepared by using a mixed solvent of an organic solvent having defoaming action (e.g., methanol) and water. The weight ratio of water to methanol is desirably from 0/100 to 99/1, more preferably from 0/100 to 91/9. Using such a mixed solvent can prevent bubbles from generating and can remarkably reduce defects in the surface of the alignment film and the optically anisotropic layer.

The coating method to be utilized upon formation of the alignment film is preferably a spin-coating method, a dip coating method, a curtain coating method, an extrusion coating method, a rod coating method, or a roll coating method. The rod coating method is especially preferred. The thickness of the alignment film after being dried is preferably from 0.1 to 10 nm. Drying under heating can be carried out at 20 to 110° C. In order to form sufficient cross-linkage, drying is desirably carried out at 60 to 100 C.°, particularly preferably at 80 to 100 C°. The drying may be completed in 1 minute to 36 hours, preferably in 1 minute to 30 minutes. The pH is desirably set in an optimal range for a cross-linking agent to be used and, when glutaraldehyde is used, the pH is preferably set in a range of from 4.5 to 5.5.

The alignment film is preferably provided on the surface of a transparent support. The alignment film can be obtained by applying a rubbing treatment to the surface of the polymer layer after cross-linking the polymer layer as described above.

As the rubbing treatment, any known treatment widely used in a liquid-crystal alignment step of LCD. That is, a method of attaining alignment by rubbing the surface of the alignment film with paper, gauze, felt, rubber, nylon fibers, polyester fibers or the like in a definite direction can be employed. Generally, the rubbing treatment is carried out by rubbing several times with a fabric in which fibers having a uniform length and line thickness are implanted averagely.

Molecules of the liquid crystalline compound are aligned by coating the aforesaid composition on the rubbing-treated surface of the alignment film. Then, if necessary, the alignment film polymer and the multi-functional monomer contained in the optically anisotropic layer are reacted with each other, or the alignment film polymer is cross-linked by using a cross-linking agent to form the aforesaid optically anisotropic layer.

[Polarizing Plate]

The polarizing plate of the invention has a polarizing film and two protective films for protecting both surfaces of the polarizing film, in which the optical film of the invention is preferably used as at least one of the polarizing plate-protective films.

As the polarizing film of the polarizing plate, there are an iodine-containing polarizing film, a dye-containing polarizing film using a dichroic dye, and a polyene-containing polarizing film. The iodine-containing polarizing film and the dye-containing polarizing film can be produced generally using a polyvinyl alcohol film.

A structure of the polarizing plate is preferred wherein the side of the optical film, on which the optically anisotropic layer containing the liquid crystalline compound is provided, is adhered to one side of the polarizing film via an adhesive or via other substrate, with a protective film being provided on the other side of the polarizing film. More preferred is the structure wherein the optically anisotropic layer of the optical film is directly adhered to the polarizing film via an adhesive. In order to improve adhesion properties between the optically anisotropic layer and the polarizing film, the surface of the optically anisotropic layer is preferably subjected to surface treatment (e.g., glow discharge treatment, corona discharge treatment, plasma treatment, ultraviolet ray (UV) treatment, flame treatment, saponification treatment, or washing with a solvent). It is also possible to provide an adhesive layer (undercoat layer) on the optically anisotropic layer.

Also, an adhesive layer may be provided on the opposite side of the other protective film, which constitutes the polarizing plate, to the polarizing film.

Use of the optical film of the invention as a protective film for a polarizing plate enables preparation of a polarizing plate having excellent physical strength, antistatic properties, and durability in addition to optical performance expected for a λ/4 film or the like.

Also, the polarizing plate of the invention can have optically compensatory function. In such case, it is preferred that the optical film is provided on only one side of the surface side and the back side of two surface protective films and that the surface protective film on the side opposite to the optical film side of the polarizing plate is an optically compensatory film.

[Image Display Device]

The optical film and the polarizing plate of the invention can be used to constitute the surface of an image display device for the use of, for example, organic electroluminescence devices, touch panels, 3D display devices, and spectacles for viewing a 3D display device.

### Example

The characteristics of the invention will be more specifically described by reference to Working Examples and Comparative Examples. Materials, amounts of use, proportions, contents of treatments, treating manners, etc. can properly be altered as long as the gist of the invention is not exceeded. Therefore, the scope of the invention is not to be construed to be restricted by the specific examples to be described hereinafter.

[Production Example 1 of Optical Film]

### [Production 1 of Optical Substrate]

### <Preparation of Transparent Support (Cellulose Acetate Film T1)>

The following composition was placed in a mixing tank, and was stirred under heating to solve respective components, thus a cellulose acetate solution being prepared.

### (Formulation of Cellulose Acetate Solution)

| | | |
|---|---|---|
| Cellulose acetate of 60.7 to 61.1% in degree of | 100 | parts by weight |
| acetification | | |
| Triphenyl phosphate (plasticizer) | 7.8 | parts by weight |
| Biphenyldiphenyl phosphate (plasticizer) | 3.9 | parts by weight |
| Methylene chloride (first solvent) | 336 | parts by weight |
| Methanol (second solvent) | 29 | parts by weight |
| 1-Butanol (third solvent) | 11 | parts by weight |

In a separate mixing tank were placed 16 parts by weight of the following retardation-increasing agent (A), 92 parts by weight of methylene chloride, and 8 parts by weight of methanol, and the resulting mixture was stirred under heating to prepare a solution of the retardation-increasing agent. 25 parts by weight of the solution of the retardation-increasing agent was mixed with 474 parts by weight of the cellulose acetate solution, and the resulting mixture was sufficiently stirred to prepare dope A containing 22.4% by weight of solid components. The addition amount of the retardation-increasing agent was 6.0 parts by weight per 100 parts by weight of cellulose acetate.

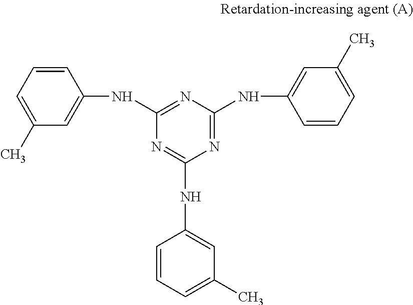 [SMILES: Cc1cccc(Nc2nc(Nc3cccc(C)c3)nc(Nc3cccc(C)c3)n2)c1]

Silica particles of 16 nm in average particle size (AEROSIL R972 manufactured by Nippon Aerosil Co., Ltd.) were added to the above-described dope A in an amount of 0.02 part by weight per 100 parts by weight of cellulose acetate to prepare dope B containing the matting agent. The concentration of solid components was adjusted to 19% by weight by using the solvent having the same solvent formulation as with the dope A.

Casting was conducted using a band stretching machine so that the dope A formed the main stream and the dope B formed both the undermost layer and the uppermost layer. When the surface temperature of the film on the band reached 40° C., the film was dried for 1 minute with a 70° C. hot air, and then the film was removed from the band. The film was then dried for 10 minutes with a 140° C. drying air to prepare cellulose acetate film T1 containing 0.3% by weight of the residual solvent. The casting amount was adjusted so that the thickness of the undermost layer and the uppermost layer both containing the matting agent became 3 nm and the thickness of the main stream became 54 μm.

The thus-obtained continuous cellulose acetate film T1 had a width of 2300 mm and a thickness of 60 μm. Also, in-plane retardation (Re) was 6 nm, and retardation (Rth) in thickness direction was 60 nm

<Preparation of Transparent Support (Cellulose Acetate Film T2)>

Cellulose acetate film T2 was prepared in the same manner as in the above-described preparation of the cellulose acetate film T1 except for changing the thickness of the film by adjusting the casting amount of the dope A. The entire thickness of the cellulose acetate film T2 was 80 μm, and Re and Rth were 8 nm and 78 nm, respectively.

<Preparation of Transparent Support (Cellulose Acetate Film T3)>

The following composition was placed in a mixing tank, and was stirred under heating to dissolve each component, thus, a cellulose acetate solution containing 22% by weight of solid components (dope C) being prepared.

### (Formulation of Cellulose Acetate Solution)

| | | |
|---|---|---|
| Cellulose acetate of 60.7 to 61.1% in degree of | 100 | parts by weight |
| acetification | | |
| Triphenyl phosphate (plasticizer) | 7.8 | parts by weight |
| Biphenyldiphenyl phosphate (plasticizer) | 3.9 | parts by weight |
| UV ray absorbent (TINUVIN 328, manufactured | 0.9 | part by weight |
| by CIBA Japan) | | |
| UV ray absorbent (TINUVIN 326, manufactured | 0.2 | part by weight |
| by CIBA Japan) | | |
| Methylene chloride (first solvent) | 336 | parts by weight |
| Methanol (second solvent) | 29 | parts by weight |
| 1-Butanol (third solvent) | 11 | parts by weight |

Silica particles of 16 nm in average particle size (AEROSIL R972 manufactured by Nippon Aerosil Co., Ltd.) were added to the above-described dope C in an amount of 0.02 part by weight per 100 parts by weight of cellulose acetate to prepare dope D containing the matting agent. The concentration of solid components was adjusted to 19% by weight by using the solvent having the same solvent formulation as with the dope C.

Casting was conducted using a band stretching machine so that the dope C formed the main stream and the dope D formed both the undermost layer and the uppermost layer. When the surface temperature of the film on the band reached 40° C., the film was dried for 1 minute with a 70° C. hot air, and then the film was removed from the band. The film was then dried for 10 minutes with a 140° C. drying air to prepare cellulose acetate film T3 containing 0.3% by weight of the residual solvent. The casting amount was adjusted so that the thickness of the undermost layer and the uppermost layer both containing the matting agent became 3 nm and the thickness of the main stream became 74 μm.

The thus-obtained continuous cellulose acetate film T3 had a width of 2300 mm and a thickness of 80 μm. Also, in-plane retardation (Re) was 3 nm, and retardation (Rth) in thickness direction was 45 nm

<<Formation of Optically Anisotropic Layer Containing Liquid Crystalline Compound>>

(Saponification Treatment with Alkali)

The cellulose acylate film T1 was passed between induction heating rolls of 60° C. to increase the temperature of the film surface to 40° C., and then an alkali solution of the following formulation was coated on the band surface of the film in a coating amount of 14 ml/m² using a bar coater. The film was then conveyed for 10 seconds under a steam type infrared ray heater heated to 100° C. (manufactured by NORITAKE Co., Limited). Successively, pure water was applied in an amount of 3 ml/m² similarly using a bar coater. Subsequently, after repeating 3 times the procedures of washing with water by a fountain coater and removing water by an air knife, the film was conveyed through a 70° C. drying zone for 10 seconds to dry, thus a cellulose acylate film subjected to saponification treatment with alkali being prepared.

(Formulation of the Alkali Solution)

### Formulation of Alkali Solution (Parts by Weight)

| | |
|---|---|
| Potassium hydroxide | 4.7 parts by weight |
| Water | 15.8 parts by weight |
| Isopropanol | 63.7 parts by weight |
| Surfactant SF-1: C₁₄H₂₉O(CH₂CH₂O)₂0H | 1.0 part by weight |
| Propylene glycol | 14.8 parts by weight |

### (Formation of Alignment Film)

A coating liquid of the following formulation for forming an alignment film was continuously coated on the continuous cellulose acetate film subjected to the saponification treatment as described above, using a #14 wire bar. The coated film was dried for 60 seconds with a 60° C. hot air and, further, for 120 seconds with a 100° C. hot air.

### Formulation of the Coating Liquid for Forming Alignment Film:

| | | |
|---|---|---|
| Modified polyvinyl alcohol described below | 10 | parts by weight |
| Water | 371 | parts by weight |
| Methanol | 119 | parts by weight |
| Glutaraldehyde | 0.5 | part by weight |
| Photo polymerization initiator | 0.3 | part by weight |
| (Irgacure 2959, manufactured by CIBA Japan) | | |

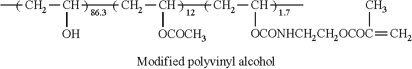

[Formation of Optically Anisotropic Layer Containing Discotic Liquid Crystalline Compound]

The above-prepared alignment film was continuously subjected to rubbing treatment. In this occasion, the longitudinal direction of the continuous film and the conveying direction were parallel to each other, and the rotation axis of the rubbing roller was tilted at 45° in the counterclockwise direction with respect to the longitudinal direction of the film.

A coating liquid B of the following formulation containing a discotic crystalline compound was continuously coated on the above-prepared alignment film using a #2.7 wire bar. The film-conveying velocity (V) was adjusted to 36 m/min. The film was heated for 90 seconds with a 120° C. hot air for removing the solvent of the coating liquid and ripening alignment of the discotic liquid crystalline compound. Successively, UV irradiation was conducted at 80° C. to fix alignment of the liquid crystalline compound to form a 1-nm thick optically anisotropic layer, thus an optical substrate F1 being obtained.

Formulation of the Coating Liquid (B) for Forming the Optically Anisotropic Layer

| | | |
|---|---|---|
| Discotic liquid crystalline compound shown below | 100 | parts by weight |
| Photo polymerization initiator | 3 | parts by weight |
| (Irgacure 907, manufactured by CIBA GEIGY) | | |
| Sensitizing agent | 1 | part by weight |
| (KAYACURE DETX, manufactured by Nippon Kayaku) | | |
| Pyridinium salt shown below | 1 | part by weight |
| Fluorine-containing polymer (FP2) shown below | 0.4 | part by weight |
| Methyl ethyl ketone | 252 | parts by weight |

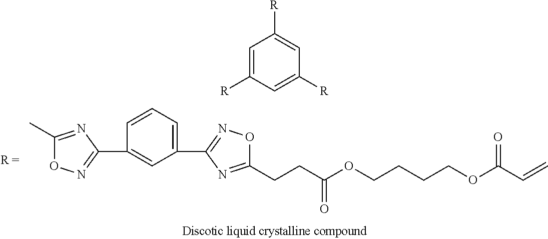

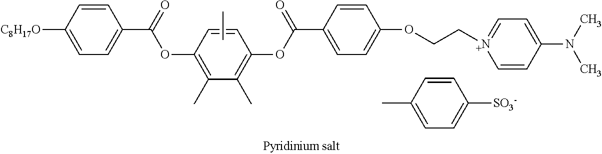

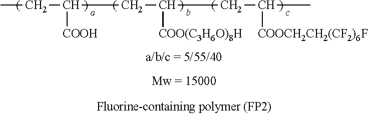

The prepared optical substrate F1 had Re at 550 nm of 145 nm and an Nz value of 0.53. The slow axis direction was at right angle with the rotation axis of the rubbing roller. That is, the slow axis was in the direction of 45° clockwise with respect to the longitudinal direction of the support. The average tilt angle of the disc planes of the discotic crystalline molecules with respect to the film plane was 90°, and thus it was confirmed that the discotic liquid crystal was vertically aligned with respect to the film plane.

[Production 2 of Optical Substrate]

In production 1 of the optical substrate, the cellulose acetate film was changed to T2, and the band-side surface of the cellulose acetate film T2 was subjected to saponification treatment. Further, an alignment film was provided in the same manner as in Production Example 1. The thus-prepared alignment film was continuously subjected to rubbing treatment. In this occasion, the longitudinal direction of the continuous film and the conveying direction were parallel to each other, and the rotation axis of the rubbing roller was adjusted to the direction of 45° counterclockwise with respect to the longitudinal direction of the film.

A coating liquid C of the following formulation containing a discotic crystalline compound was continuously coated on the above-prepared alignment film using a #3.6 wire bar. The film-conveying velocity (V) was adjusted to 36 m/min. The film was heated for 90 seconds with a 120° C. hot air for removing the solvent of the coating liquid and ripening alignment of the discotic liquid crystalline compound. Successively, UV irradiation was conducted at 80° C. to fix alignment of the liquid crystalline compound to form an optically anisotropic layer having a thickness of 1.6 μm, thus an optical substrate F2 being obtained.

The prepared optical substrate F2 had Re at 550 nm of 125 nm and an Nz value of 0.9. The slow axis direction was at right angle with the rotation axis of the rubbing roller. That is, the slow axis was in the direction of 45° clockwise with respect to the longitudinal direction of the support. The average tilt angle of the disc planes of the discotic crystalline molecules with respect to the film plane was 90°, and thus it was confirmed that the discotic liquid crystal was vertically aligned with respect to the film plane.

Formulation of the Coating Liquid (C) for Forming the Optically Anisotropic Layer

| | | |
|---|---|---|
| Discotic liquid crystalline compound shown below | 91 | parts by weight |
| Acrylate monomer shown below | 5 | parts by weight |
| Photo polymerization initiator | 3 | parts by weight |
| (Irgacure 907, manufactured by CIBA GEIGY) | | |
| Sensitizing agent | 1 | part by weight |
| (KAYACURE DETX, manufactured by Nippon Kayaku) | | |
| Pyridinium salt shown below | 0.5 | part by weight |
| Fluorine-containing polymer (FP1) shown below | 0.2 | part by weight |
| Fluorine-containing polymer (FP3) shown below | 0.1 | part by weight |
| Methyl ethyl ketone | 252 | parts by weight |

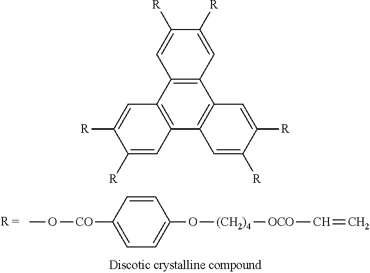

Acrylate monomer:
Ethylene oxide modified trimethylolpropane triacrylate (V#360), manufactured by OSAKA ORGANIC CHEMICAL INDUSTRY LTD.)

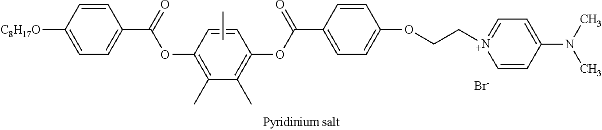

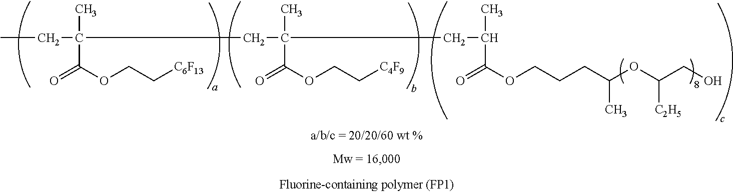

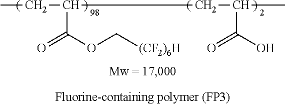

[Production 3 of Optical Substrate]

An optical substrate F3 was prepared in the same manner as in the method for producing the optical substrate F1 except for changing the cellulose acetate film to T3 in the production process 1 for the optical substrate. The prepared optical substrate F3 had Re at 550 nm of 143 nm and an Nz value of 0.4.

[Production 4 of Optical Substrate]

A cellulose acetate (dope C) was prepared in the same manner as in the method for preparing the above-described cellulose acetate film T3, the dope C served as a dope for inner layer.

Silica particles of 16 nm in average particle size (AEROSIL R972 manufactured by Nippon Aerosil Co., Ltd.) were added to the above-described dope C in an amount of 0.05 part by weight per 100 parts by weight of cellulose acetate to prepare dope E containing the matting agent for outer layer. The concentration of solid components in the dope E was adjusted to 20% by weight by using the solvent having the same solvent formulation as with the dope C.

Silica particles of 16 nm in average particle size (AEROSIL R972 manufactured by Nippon Aerosil Co., Ltd.) were added to the above-described dope C in an amount of 0.25 part by weight per 100 parts by weight of cellulose acetate to prepare dope F containing the matting agent for outer layer. The concentration of solid components in the dope F was adjusted to 20% by weight by using the solvent having the same solvent formulation as with the dope C.

The dopes C, D and E were co-casted on a mirror-surface stainless substrate so that the dope C formed an inner layer, the dope E formed the undermost layer, and the dope F formed the uppermost layer. When the surface temperature of the film on the substrate reached 40° C., the film was dried for 1 minute with a 70° C. hot air, and then the film was removed from the band. The film was then dried for 10 minutes with a 140° C. drying air to prepare cellulose acetate film T4. The casting amount was adjusted so that the thickness of the outer layer formed in a substrate-side, the inner layer, and the outer layer formed in an air-surface-side became 3 μm, 75 μm, and 2 μm, respectively.

The thus-obtained continuous cellulose acetate film T4 had a width of 2300 mm and a thickness of 80 μm. Also, in-plane retardation (Re) was 2 nm, and retardation (Rth) in thickness direction was 40 nm

An optical substrate F4 was prepared in the same manner as in the method for producing the optical substrate F2 except for changing the cellulose acetate film to T4 in the production process 2 for the optical substrate. On this occasion, an optical anisotropic layer was formed on the side of the substrate having the mirror surface in the cellulose acetate film T4. The prepared optical substrate F4 had Re at 550 nm of 142 nm and an Nz value of 0.5.

[Lamination Hard Coat Layer]

A coating liquid for each hard coat layer was prepared as shown below, and was coated on the above-described optical substrate, followed by drying and curing to obtain optical film samples 101 to 123.

(Preparation of Coating Liquid A-1 for Forming Hard Coat Layer)

The following composition was placed in a mixing tank, stirred, and passed through a polypropylene filter of 0.4 μm in pore size to prepare a coating liquid A-1 for forming a hard coat layer (concentration of solid component: 58% by weight)

Solvent

| | |
|---|---|
| Methyl acetate | 36.2 parts by weight |
| Methyl ethyl ketone | 36.2 parts by weight |
| (a) monomer: PETA | 77.0 parts by weight |
| (b) monomer: urethane monomer | 20.0 parts by weight |
| Photo polymerization initiator | 3.0 parts by weight |
| (Irgacure 184, manufactured by CIBA | |
| Specialty Chemicals) | |
| Leveling agent (SP-13) | 0.02 part by weight |

Respective components were mixed as shown in the following Table 1 in a manner analogous to the method for the coaling liquid 1 for forming the hard coat layer so as to attain the ratio described in Table 1, thus coating liquids A-2 to A-12 (containing 58% by weight of solid components) for forming the hard coat layer being prepared.

Incidentally, in the Table 1, amount of each component other than a solvent is represented by a ratio of each component to sum of solid components in a coating liquid. A ratio of the solvent is represented by a ratio of amount of each solvent to amount of total solvent.

TABLE 1

| Hard | | | | | Poly- | | | | | | | | | |
|---|---|---|---|---|---|---|---|---|---|---|---|---|---|---|
| Coat | | | | | meriza- | | | Other | | | | | | |
| Layer | Monomer | | Monomer | | tion | Leveling Agent | | Additives | | | | | | |
| Composi- | | Con- | | Con- | Initiator | | Con- | | Con- | Solvent 1 | | Solvent 2 | | |
| tion No | Kind | tent* | Kind | tent* | Irg. 184 | Kind | tent* | Kind | tent* | Kind | Ratio | Kind | Ratio | Note |
| A-1 | PETA | 77% | urethane | 20% | 3% | SP-13 | 0.02% | — | — | methyl acetate | 50% | MEK | 50% | invention |
| | | | monomer | | | | | | | | | | | |
| A-2 | PETA | 77% | urethane | 20% | 3% | SP-13 | 0.02% | — | — | MiBK | 100% | — | — | comparative |
| | | | monomer | | | | | | | | | | | example |
| A-3 | PETA | 77% | urethane | 20% | 3% | SP-13 | 0.02% | — | — | methyl acetate | 100% | — | — | comparative |
| | | | monomer | | | | | | | | | | | example |
| A-4 | PETA | 77% | EB5129 | 20% | 3% | SP-13 | 0.02% | — | — | methyl acetate | 50% | MEK | 50% | invention |
| A-5 | PET-30 | 87% | A-400 | 10% | 3% | SP-13 | 0.02% | — | — | dimethyl carbonate | 40% | MiBK | 60% | invention |
| A-6 | PET-30 | 87% | A-400 | 10% | 3% | SP-13 | 0.02% | — | — | MiBK | 100% | — | — | comparative |
| | | | | | | | | | | | | | | example |
| A-7 | PET-30 | 87% | A-400 | 10% | 3% | SP-13 | 0.02% | — | — | dimethyl carbonate | 100% | — | — | comparative |
| | | | | | | | | | | | | | | example |
| A-8 | PET-30 | 97% | — | — | 3% | SP-13 | 0.02% | — | — | dimethyl carbonate | 40% | MiBK | 60% | invention |
| A-9 | PET-30 | 87% | A-400 | 10% | 3% | — | — | — | — | dimethyl carbonate | 40% | MiBK | 60% | invention |
| A-10 | PET-30 | 87% | A-400 | 10% | 3% | X22-4272 | 0.02% | — | — | dimethyl carbonate | 40% | MiBK | 60% | invention |
| A-11 | A-TMMT | 87% | A-400 | 10% | 3% | SP-13 | 0.02% | — | — | dimethyl carbonate | 40% | MiBK | 60% | invention |
| A-12 | A-TMMT | 78% | A-400 | 9% | 3% | SP-13 | 0.02% | IP-9 | 10% | dimethyl carbonate | 40% | MiBK | 60% | invention |

Each of the compounds used is shown below.
PETA: manufactured by Shin-Nakamura Chemical Co., Ltd.; compound of the following structure; weight-average molecular weight is 325; number of functional groups per molecule is 3.5 (average number); SP value is 21.2. 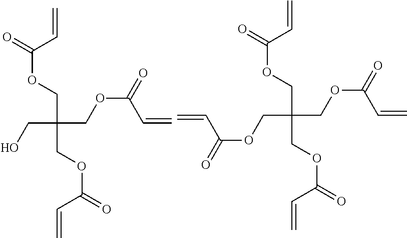
Urethane monomer: compound of the following structure; weight-average molecular weight is 596; number of functional groups per molecule is 4; SP value is 22.0. 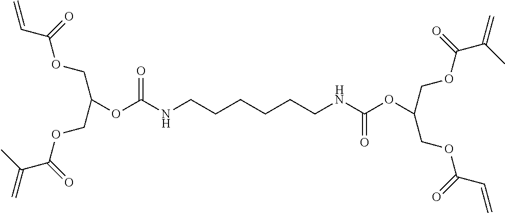 [SMILES: C=CC(=O)OCC(COC(=O)C(=C)C)OC(=O)NCCCCCCNC(=O)OC(COC(=O)C=C)COC(=O)C(=C)C]
EB5129: manufactured by UCB; compound of the following structure; weight-average molecular weight is 765; number of functional groups per molecule is 6; SP value is 22.1. 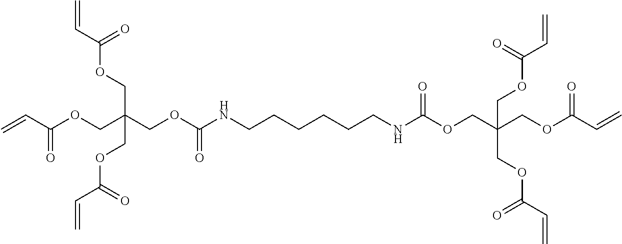 [SMILES: C=CC(=O)OCC(COC(=O)C=C)(COC(=O)C=C)COC(=O)NCCCCCCNC(=O)OCC(COC(=O)C=C)(COC(=O)C=C)COC(=O)C=C]
A-400 (manufactured by Shin-Nakamura Chemical Co., Ltd.); compound of the following structure; weight-average molecular weight is 538; number of functional groups per molecule is 2; SP value is 21.2. 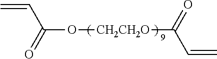
PET-30 (manufactured by NIPPON KAYAKU Co., Ltd.); mixture of a triacrylate of pentaerythritol and a tetra acrylate of pentaerythritol; weight-average molecular weight is 312; number of functional groups per molecule is 3.4 (average value); SP value is 21.2.
A-TMMT: manufactured by Shin-Nakamura Chemical Co., Ltd.; compound of the following structure; weight-average molecular weight is 352; number of functional groups per molecule is 4; SP value is 20.7. 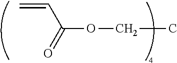
Weight-average molecular weight: 304; number of functional groups per molecule: 4
Leveling agent (SP-13): 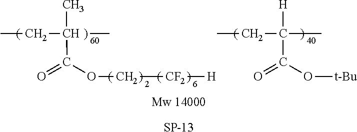
(X22-4272): polyether-modified silicone oil (X22-4272; manufactured by Shin-Etsu Chemical Co., Ltd.)
Irg. 184: photo polymerization initiator Irgacure 184 (manufactured by CIBA Japan)
IP-9: Aforesaid conductive compound IP-9

(Preparation of Optical Film 101)

The coating liquid A-1 for forming the hard coat layer was coated on the side of the support of the optical substrate F1 produced in the above-described Production Example using a die coater, the side not being provided with the liquid crystalline compound-containing layer (coating amount in terms of solid components: 12 g/m²). After drying at 100° C. for 60 seconds, the coated layer was cured by irradiating with UV rays at an irradiance of 400 nW/cm² and an irradiation amount of 300 mJ/cm² using an air-cooled metal halide lamp of 160-W/cm (manufactured by EYE GRAPHICS CO., LTD.), while purging the system with nitrogen to provide an atmosphere having an oxygen concentration of 0.1% by volume, whereby the hard coat layer a was formed. Thus, an optical film sample No. 101 was prepared.

Optical film samples No. 102 to No. 123 were prepared by selecting the optical substrate and the coating composition for forming the hard coat layer according to the combinations shown in Table 2. In this occasion, the hard coat layer composition was coated on the side of the support surface in a coating amount of 12 g/m² in terms of solid components, the side not being provided with the liquid crystalline compound-containing layer.

As a result of observation of the surface of the optical substrate using an electron microscope and an AFM before coating the hard coat layer, it was found that secondary aggregate particles of silica having diameter of 1 to 2 μm existed in all of F1, F2, F3 and F4. The height of projections of the support around the positions of the silica secondary aggregate particles were about 0.1 to 2 μm.

The Re and Nz values of the optical film after forming the hard coat layer do not change with respect to those of the optical film before forming the hard coat layer.

[Evaluation of Optical Film]

Various properties of each of the optical films were evaluated according in the following manner. Results thus obtained are shown in Table 2.

### (1) Repelling Problem

Occurrence of repelling problem on the surface of the hard coat layer-coated side of each optical film was visually observed in the area of 30 cm in width and 30 m in length, and was ranked according to the following criteria.
A: Occurrence of repelling problem is less than 0.05 in number/m.
B: Occurrence of repelling problem is from 0.05 to less than 0.1 in number/m.
C: Occurrence of repelling problem is from 0.1 to less than 1.0 in number/m.
D: Occurrence of repelling problem is more than 1.0 in number/m.

In order to evaluate storage with time of the optical substrates each having the optically anisotropic layer containing liquid crystalline compound and prepared above, each optical substrate was wound up by a roller with a width of 300 mm and a length of 50 m. After being stored in the roll state at 40° C. and a relative humidity of 55% for 1 week, each of the optical substrates was coated with the composition for forming hard coat layer according to the Production Example of optical film, and occurrence of repelling was evaluated.

Evaluation result with an optical substrate not having been stored with time is shown as “FR”, whereas evaluation result with an optical substrate having been stored with time is shown as “after storage with time”.

(2) Interference Unevenness of Hard Coat Layer

In each of optical film, a side on which the hard coat layer is not provided was rubbed with sandpaper to roughen the surface, and a black-plastered PET film was laminated on the surface. Each sample was viewed under a three-wavelength fluorescent lamp (manufactured by Toshiba Lightening & Technology Corporation; mellow Z EX-D) at an illuminance of 1000 lx and 500 lx. A higher illuminance made it easier to detect interference fringes. Degree of the interference unevenness was evaluated in the following 4 grades.
A: Interference fringes are scarcely observed even under an illuminance of 1000 lx.
B: Interference fringes are slightly observed under an illuminance of 1000 lx, but are not substantially observed under an illuminance of 500 lx.
C: Interference fringes are observed even under an illuminance of 500 lx.
D: Interference fringes are at an anxious level under an illuminance of 500 lx.

(3) Curling, F-Method Curling

Each of the thus-prepared film is cut to a size of 35 mm×125 mm, was vertically set on a curling plate so that the sample did not exceed the braces for setting the sample, and was conditioned for 10 hours at 25° C. and a relative humidity of 60%. After conditioning, it was read to what division of the curling plate the end of the sample was curled (═F method curling value). On this occasion, a sign of ± is applied depending upon the curling direction of the film, and a larger absolute value means a stronger curling.

Curling (absolute value) of each film was evaluated according to the following criteria:
A: 0.5 or less;
B: more than 0.5 and not more than 1.5; and
C: more than 1.5.

(4) Pencil Hardness

Evaluation of pencil hardness described in JIS K 5400 was conducted, and the hard coat layer-coated side was evaluated according to the following criteria:
A: 4H or more;
B: 3H
C: less than 2H

TABLE 2

| | | Hard Coat | Repelling Trouble | | Inter- | | | |
|---|---|---|---|---|---|---|---|---|
| Optical | Optical | Layer | | After | ference | Pencil | | |
| Film | Substrate | Composition | | Storage | Uneven- | Hard- | Curl- | |
| No. | No. | No. | Fr | With Time | ness | ness | ing | Note |
| 101 | F1 | A-1 | A | A | A | A | A | invention |
| 102 | F1 | A-2 | D | D | D | A | A | comparative |
| | | | | | | | | example |
| 103 | F1 | A-3 | A | B | C | B | C | comparative |
| | | | | | | | | example |
| 104 | F1 | A-4 | A | A | A | A | A | invention |
| 105 | F1 | A-5 | A | A | A | A | A | invention |
| 106 | F1 | A-6 | D | D | D | A | A | comparative |
| | | | | | | | | example |
| 107 | F1 | A-7 | A | B | C | B | C | comparative |
| | | | | | | | | example |
| 108 | F1 | A-8 | A | B | B | A | A | invention |
| 109 | F1 | A-9 | B | C | A | A | A | invention |
| 110 | F1 | A-10 | A | A | A | A | A | invention |
| 111 | F1 | A-11 | A | A | A | A | A | invention |
| 112 | F1 | A-12 | A | A | A | A | A | invention |
| 113 | F2 | A-1 | A | A | A | A | A | invention |
| 114 | F2 | A-4 | A | A | A | A | A | invention |
| 115 | F2 | A-5 | A | A | A | A | A | invention |
| 116 | F2 | A-11 | A | A | A | A | A | invention |
| 117 | F2 | A-12 | A | A | A | A | A | invention |
| 118 | F3 | A-1 | A | A | A | A | A | invention |
| 119 | F3 | A-5 | A | A | A | A | A | invention |
| 120 | F3 | A-12 | A | A | A | A | A | invention |
| 121 | F4 | A-1 | A | A | A | A | A | invention |
| 122 | F4 | A-5 | A | A | A | A | A | invention |
| 123 | F4 | A-12 | A | A | A | A | A | invention |

As shown in Table 2, it is seen that, by employing a solvent having the formulation of the invention as a solvent for the hard coat layer, an optical film can be obtained which suffers less repelling problem and shows less interference unevenness and less curling and which has an excellent pencil hardness. It is also seen that, by employing mixture formulation of the invention as the formulation of the curing monomers, interference unevenness and curling are reduced, and an excellent pencil hardness is attained.

[Production Example 2 of Optical Film]

Coating liquids for the following layers were prepared.

### (Preparation of a Coating Liquid for Forming a Medium Refractive Index Layer)

A phosphorous-containing tin oxide (PTO) dispersion (ELCOM JX-1001 PTV manufactured by Catalysts & Chemicals Industries Co., Ltd.), and a mixture (DPHA) of dipentaerythritol pentaacrylate and dipentaerythritol hexaacrylate were mixed to prepare a coating liquid for a medium refractive index layer having a refractive index adjusted to 1.62 after curing.

(Preparation of a Coating Liquid for Forming a High Refractive Index Layer)

61.9 parts by weight of methyl ethyl ketone, 3.4 parts by weight of methyl isobutyl ketone, and 1.1 parts by weight of cyclohexanone were added to 15.7 parts by weight of a ZrO₂ fine particle-containing hard coat agent (Desolite Z7404 [refractive index: 1.72, solid content concentration: 60% by weight; content of zirconium oxide fine particles: 70% by weight (based on solid content), average particle size of zirconium oxide fine particles: about 20 nm; solvent composition: methyl isobutyl ketone/methyl ethyl ketone=9/1; manufactured by JSR Corp.]). The mixture was stirred, and then filtered through a polypropylene-made filter having a pore size of 0.4 μm to prepare a coating liquid A for a high refractive index layer.

(Preparation of a Coating Liquid for Forming a Low Refractive Index Layer)

The following components were mixed as shown below, and the resulting mixture was dissolved in a 85/15 mixture (weight ratio) of MEK/MMPG-AC to prepare a coating liquid for a low refractive index layer containing 5% by weight of solid component.

Formulation of Coating Liquid for a Low Refractive Index Layer

| | | |
|---|---|---|
| Perfluoro-olefin copolymer shown below | 15 | parts by weight |
| DPHA | 7 | parts by weight |
| Defensa MCF-323 | 5 | parts by weight |
| Fluorine-containing compound shown below | 20 | parts by weight |
| Hollow silica particles (as solid component) | 50 | parts by weight |
| Irgacure 127 | 3 | parts by weight |

Used compounds are shown below.
Perfluoro-olefin copolymer: 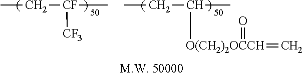
In the above structural formula, 50:50 represents a molar ratio.
Fluorine-containing compound: 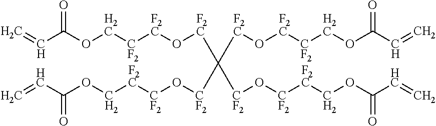 [SMILES: C=CC(=O)OCC(F)(F)C(F)(F)OC(F)(F)C(C(F)(F)OC(F)(F)C(F)(F)COC(=O)C=C)(C(F)(F)OC(F)(F)C(F)(F)COC(=O)C=C)C(F)(F)OC(F)(F)C(F)(F)COC(=O)C=C]
DPHA: Mixture of dipentaerythritol pentaacrylate and dipentaerythritol hexaalkylate; manufactured by Nippon Kayaku
Defensa MCF-323: Fluorine-containing surfactant; manufactured by Dainippon Ink & Chemicals, Inc.
Irgacure 127: Photo polymerization initiator; manufactured by CIBA Japan
Hollow silica: Dispersion of hollow silica particles (average particle size: 45 nm; refractive index: 1.25; surface-treated with an acryloyl group-containing silane coupling agent; concentration of MEK dispersion: 20%)
MEK: Methyl ethyl ketone
MMPG-Ac: Propylene glycol monomethyl ether acetate

(Formation of Hard Coat Layer, Medium Refractive Index Layer, High Refractive Index Layer, and Low Refractive Index Layer)

The same procedures as in Production Example 1 of the above-described optical films 101 to 123 were conducted except for changing irradiance of UV irradiation upon curing the hard coat layer to 150 mJ/cm², whereby optical films each having the hard coat layer were prepared. On this hard coat layer was coated the above-described coating liquid for the medium refractive index layer. Drying conditions were 90° C. and 30 seconds. As to UV ray irradiation conditions, UV rays was irradiated with an irradiance of 300 mW/cm² and an irradiation amount of 240 mJ/cm² using an air-cooled metal halide lamp (manufactured by EYE GRAPHICS CO., LTD.) of 180-W/cm, while purging the system with nitrogen to provide an atmosphere having an oxygen concentration of 1.0% by volume or less. The medium refractive index layer had a refractive index of 1.62 and a film thickness of 60 nm

Successively, on the formed medium refractive index layer was coated the above-described coating liquid for the high refractive index layer. Drying conditions were 90° C. and 30 seconds. As to UV ray irradiation conditions, UV rays was irradiated with an irradiance of 300 mW/cm² and an irradiation amount of 240 mJ/cm² using an air-cooled metal halide lamp (manufactured by EYE GRAPHICS CO., LTD.) of 240-W/cm, while purging the system with nitrogen to provide an atmosphere having an oxygen concentration of 1.0% by volume or less. The high refractive index layer had a refractive index of 1.72 and a film thickness of 110 nm

Successively, on the formed high refractive index layer was coated the above-described coating liquid for the low refractive index layer. Drying conditions for the low refractive index layer were 60° C. and 60 seconds. As to UV ray irradiation conditions, UV rays was irradiated with an irradiance of 600 mW/cm² and an irradiation amount of 300 mJ/cm² using an air-cooled metal halide lamp (manufactured by EYE GRAPHICS CO., LTD.) of 240-W/cm, while purging the system with nitrogen to provide an atmosphere having an oxygen concentration of 0.1% by volume or less. The low refractive index layer had a refractive index of 1.34 and a film thickness of 95 nm.

As is described above, optical films 201 to 223 having a hard coat layer, a medium refractive index layer, a high refractive index layer, and a low refractive index layer formed in this order were prepared. These films showed a reflectance at 380 to 780 nm of as low as about 0.3%, thus having excellent antireflection performance.

[Production Example 3 of Optical Film]

The same procedures as in Production Example 1 of the above-described optical films 101 to 123 were conducted except for changing irradiance of UV irradiation upon curing the hard coat layer to 150 mJ/cm², whereby optical films each having the hard coat layer were prepared. On this hard coat layer was coated the above-described coating liquid for the low refractive index layer. Drying conditions for the low refractive index layer were 60° C. and 60 seconds. As to UV ray irradiation conditions, UV rays was irradiated with an irradiance of 600 mW/cm² and an irradiation amount of 300 mJ/cm² using an air-cooled metal halide lamp (manufactured by EYE GRAPHICS CO., LTD.) of 240-W/cm, while purging the system with nitrogen to provide an atmosphere having an oxygen concentration of 0.1% by volume or less. The low refractive index layer had a refractive index of 1.34 and a film thickness of 95 nm

As is described above, optical films 301 to 323 having a hard coat layer and a low refractive index layer formed in this order were prepared. These films showed a reflectance at 380 to 780 nm of as low as about 1.0%, thus having excellent antireflection performance.

[Preparation 1 of Polarizing Plate and Image Display Device]

The optically anisotropic layer surface of each of the above-prepared optical films (201 to 223, 301 to 323) was washed with MEK. The washed film surface and the surface of the support of TD80UL (manufactured by FUJIFILM Corporation) were subjected to alkali saponification treatment. They were dipped in a 1.5N sodium hydroxide aqueous solution at 55° C. for 2 minutes, then washed in a water bath of room temperature, followed by neutralizing with 0.1N sulfuric acid at 30° C. Again, the films were washed in a water bath of room temperature, and were dried with a 100° C. hot air.

Successively, a 80-nm thick roll-form polyvinyl alcohol film was continuously stretched to a draw ratio of 5 in an iodine aqueous solution, and dried to obtain a 20-nm thick polarizing film. The above-described alkali saponification-treated films and a similarly alkali saponification-treated retardation film for VA (manufactured by FUJIFILM Corporation; Re/Rth at 550 nm=50/125) were prepared, and the polarizing film was sandwiched by lamination between the two films using a 3% aqueous solution of polyvinyl alcohol (manufactured by KURARAY CO. LTD.; PVA-117H) as an adhesive, with the saponification-treated surface of each film facing the polarizing film. Thus, there was prepared a polarizing plate wherein the optical film and the retardation film for VA function as protective films. In this occasion, the angle between the slow axis of the optical film and the transmission axis of the polarizer was adjusted to be 45°.

### (Mounting)

A polarizing plate on the viewing side of a TV (UN46C7000 (3D-TV) manufactured by SAMSUNG) was delaminated, and the retardation film for VA of the above-prepared polarizing plate was laminated on the LC cell through an adhesive to thereby prepare a three-dimensional display device.

A polarizing plate of LC shutter spectacles SSG-2100AB (LC shutter spectacles) manufactured by SAMSUNG and formed on the opposite side to the eye (panel side) was delaminated, and the above-described optical film was laminated thereon using an adhesive, with the support side of the optical film facing the delaminated surface. Thus, LC shutter spectacles were prepared. The slow axis of the optical film laminated on the spectacles was adjusted to meet at right angles with the slow axis of the optical film contained in the polarizing plate laminated on the TV.

### (Evaluation of Display Device)

A 3D movie was appreciated with wearing the above-prepared LC shutter spectacles in a room equipped with a fluorescent lamp under the condition that illuminance on the panel surface was about 200 lx. With the 3D-TV containing the optical film of the invention, crosstalk (double images) was scarcely viewed and displayed color tones were scarcely changed when viewing with inclining the head or in the inclined direction. Also, the displayed image was less reflective, and there was obtained an impression excellent in three dimensionality with high contrast and without discoloration of black color. On the other hand, a 3D-TV using general-use TAC film (TD80UL) showed more crosstalk and larger change in displayed color tones in comparison with the TV containing the optical film of the invention and, when slightly inclining the head, serious crosstalk is viewed. In addition, black color was discolored, and the displayed image was inferior in three dimensionality.

[Preparation 2 of Image Display Device]

A polarizing plate where the optical film 201 and the optical substrate F1 functioned as a protective film was manufactured in the same manner as in the method for manufacturing the above-described polarizing plate expect for using the optical substrate F1 in which the surface of the cellulose acetate film included was subjected to a saponification treatment instead of using the retardation film for VA. The resulting polarizing plate was provided at a surface of an organic electroluminescence device thorough an adhesive so that the low refractive index layer of the optical film 201 was provided at the outermost side. Excellent antireflection properties were obtained, no scratching and no color unevenness were found, and good display performance was obtained. Additionally, by wearing a polarized sunglass, it can be suppressed luminance deterioration caused by inclining a face and rotating a display.

### INDUSTRIAL APPLICABILITY

According to the present invention, there can be provided an optical film which can be produced with high productivity and which has an optically anisotropic layer having physical performance capable of using it at the front end position of a display device.

This application is based on Japanese patent application No. 2010-229146 filed on Oct. 8, 2010, the entire content of which is hereby incorporated by reference, the same as if set forth at length.

1. A method for producing an optical film comprising:
laminating a hard coat layer on one side of an optical substrate wound in a roll form, the optical substrate having a transparent support and an optical anisotropic layer,
wherein the transparent support is laminated on the optical anisotropic layer,
said one side is a transparent support-side of the optical substrate,
the hard coat layer is formed by coating, drying and curing a composition for forming a hard coat layer containing a curable monomer, a photo-polymerization initiator, and a solvent,
the solvent is a mixture of at least one solvent selected from (S-1) and (S-2) and at least one solvent selected from (S-3), or a mixture of at least one solvent selected from (S-1) and at least one solvent selected from (S-2):
(S-1) solvents dissolving the transparent support;
(S-2) solvents swelling the transparent support; and
(S-3) solvents neither dissolving nor swelling the transparent support, and
the monomer contained in the composition for forming the hard coat layer is a mixture of (2a) and (2b) described below, and the content of (2a) is more than the content of (2b):
(2a) compound having 3 or more functional groups per molecule, wherein an SP value of the monomer (2a) measured by Hoy method is more than 19 and less than 25 and a weight-average molecular weight of the monomer (2a) is more than 40 and less than 1600, and
(2b) urethane compound having 3 or more functional groups per molecule, an SP value of the monomer (2b) measured by Hoy method is more than 19 and less than 25 and an absolute value of differences a weight-average molecular weights of the monomer (2a) and the monomer (2b) is 150 ore more and 500 or less.

2. The method for producing an optical film according to claim 1,
wherein the solvent (S-1) dissolving the transparent support is methyl acetate or acetone,
the solvent (S-2) swelling the transparent support is methyl ethyl ketone, dimethyl carbonate, or methyl ethyl carbonate, and
the solvent (S-3) neither dissolving nor swelling the transparent support is methyl isobutyl ketone or toluene.

3. The method for producing an optical film according to claim 1,
wherein projections of from 0.1 to 3 μm are formed by matt particles on the transparent-support-side of the optical substrate.

4. The method for producing an optical film according to claim 1,
wherein the monomer contained in the composition for forming the hard coat layer is a mixture of (1a) and (1b) described below, and
the content ratio of (1a) to (1b) is 0.5% by weight to 10% by weight:
(1a) compound having 2 or less functional groups per molecule,
wherein a weight-average molecular weight of the monomer (1a) is more than 40 and less than 500 and an SP value of the monomer (1a) measured by Hoy method is more than 19 and less than 24.5, and
(1b) compound having 3 or more functional groups per molecule,
wherein a weight-average molecular weight of the monomer (1b) is more than 100 and less than 1600, an SP value of the monomer (2b) measured by Hoy method is more than 19 and less than 24.5, and a ratio of the weight-average molecular weight of the monomer (1b) to a number of functional groups per molecule is more than 70 and less than 300.

5. The method for producing an optical film according to claim 4,
wherein the weight-average molecular weight of the monomer (1a) is more than 40 and less than 400.

6. The method for producing an optical film according to claim 1,
wherein at least part of the monomer contained in the composition for forming the hard coat layer is the following (Aa):
(Aa) a compound having 1 or more photo-polymerizable group and having a structure of —(CH₂CH₂O)ₙ—, wherein n represents a number of 1 to 50.

7. The method for producing an optical film according to claim 6,
wherein the compound (Aa) contains 2 or 3 (meth)acryloyloxy groups and n is a number of 1 to 30.

8. The method for producing an optical film according to claim 1,
wherein the composition for forming the hard coat layer further contains a conductive compound (f).

9. The method for producing an optical film according to claim 1,
wherein the optical film has an in-plane retardation at 550 nm of from 80 to 200 nm and an Nz value represented by the following formula of from 0.1 to 0.9:
Nz value=0.5+Rth/Re
wherein Rth represents a retardation in a thickness direction.

10. The method for producing an optical film according to claim 1,
wherein the transparent support of the optical substrate containing a cellulose acylate.

11. The method for producing an optical film according to claim 1,
wherein at least one functional layer selected from the group consisting of an antireflection layer, an antistatic layer, a UV ray-absorbing layer, and an antifouling layer is further formed on the surface of the hard coat layer.

12. An optical film comprising:
an optically anisotropic layer containing a liquid crystalline compound;
a transparent support; and
a hard coat layer,
wherein the optically anisotropic layer, the transparent support, and the hard coat layer are laminated in this order, and
the hard coat layer is produced by the method according to claim 1.

13. An optical film comprising:
an optically anisotropic layer containing a liquid crystalline compound;
a transparent support; and
a hard coat layer,
wherein the optically anisotropic layer, the transparent support, and the hard coat layer are laminated in this order, and
a gradation region in which a compound localization gradually changes is formed between the hard coat layer and the transparent support.

14. The optical film according to claim 13,
wherein a thickness of the gradation region based on a thickness of the hard coat layer is from 5 to 150%.

15. The optical film according to claims 13,
wherein at least one functional layer selected from the group consisting of an antireflection layer, an antistatic layer, a UV ray-absorbing layer, and an antifouling layer is further formed on the surface of the hard coat layer.

16. The optical film according to claim 13,
wherein the optical film has an in-plane retardation at 550 nm of from 80 to 200 nm and an Nz value represented by the following formula of from 0.1 to 0.9:
Nz value=0.5+Rth/Re
wherein Rth: retardation in a thickness direction.

17. A polarizing plate using as a protective film the optical film according to claim 13.

18. An image display device comprising the optical film according to claim 13.

19. An image display device comprising the polarizing plate according to claim 18.
